(19) United States
(12) Patent Application Publication
(10) Pub. No.: US 2016/0158628 A1
(43) Pub. Date: Jun. 9, 2016

(54) PERFORMANCE ENHANCING BITE REGULATOR AND SELF-IMPRESSION SYSTEM AND METHOD OF CUSTOM FITTING SAME

(71) Applicant: PX3 SPORTS SCIENCE, a trade nam of P3 ATHLETICS, INC., Calgary (CA)

(72) Inventor: P. Bradley Layzell, Calgary (CA)

(21) Appl. No.: 14/906,174

(22) PCT Filed: Jul. 21, 2014
(86) PCT No.: PCT/IB2014/001362

§ 371 Date: Jan. 19, 2016

Related U.S. Application Data
(60) Provisional application No. 61/856,669, filed on Jul. 20, 2013.

(51) Int. Cl. A63B 71/08; A61C 19/05

(52) U.S. Cl. CPC A63B 71/085; A61C 19/05

(57) ABSTRACT

A method of custom fitting a bite regulator includes providing a self-impression kit with one or more bite registration tools, a bite regulator with an impression material on surfaces of the bite regulator, and instructions. The instructions one to a) determine a natural bite position of a subject utilizing the bite registration tool; b) apply heat to the bite regulator to soften the impression material; c) position the bite regulator over the upper or lower teeth of the subject; d) insert the bite registration tool in the subject's mouth; and e) form an impression of a portion of the subject's teeth in the softened impression material while the bite registration tool assists the subject in maintaining the previously determined natural bite position.

### RELATED APPLICATION DATA

This patent is related to and claims priority benefit of U.S. provisional application Ser. No. 61/856,669 filed Jul. 20, 2013 and of the same title. The entire content of this prior filed application is hereby incorporated herein by reference.

### BACKGROUND

1. Field of the Disclosure

The present invention relates generally to oral appliances, and more particularly to method of fitting a bite regulator that regulates a wearer's jaw and bite position during use to increase oxygen, neurological, and physiological response and maintain proper neuromusculoskeletal alignment under high impact and high stress environments.

2. Description of Related Art

There are many appliances and products that are to be worn in the mouth. Such appliances also can serve many different purposes. Some of these products are intended to be worn while participating in athletic endeavors. Many appliances of this type are worn by athletes as mouth guards and are intended to protect the athlete's teeth.

U.S. Pat. No. 7,404,403 discloses an oral appliance in the form of a mouth guard or sports guard. The sports guard 1 is to be placed in a mouth of a user. The guard 1 has a base member 2 with a generally U-shaped form corresponding to the outline of a jaw of a user and defines an upper channel 10 within which the upper row of teeth of a user are received. The guard also has a teeth-engaging element 3 associated with the channel 10 and made of a material that can be shaped or formed by a user to be molded to their mouth. The guard also has a shock absorption aspect associated with the base member 2 for absorbing impact shock. The shock absorption aspect utilizes open channels in the base member 2 that are to simulate air springs. The base member also has a polyethylene mixed with up to 10% of EVA. The addition of EVA is said to give the guard more flexibility. The teeth engaging element is made of EVA.

U.S. Pat. No. 6,082,363 (E-Z Gard Industries, Inc.) discloses a triple layer mouth guard with an integral shock absorbing framework. The triple layer mouth guard apparatus has a U-shaped mouth guard base with an elastomeric frame embedded therein. The frame includes a wave-shaped contact surface. The mouth guard base has inner and outer side walls that define an upper channel, which has a liner disposed therein. The liner is adapted to form around the teeth of the wearer when softened. The liner engages the teeth of the upper jaw and is made of a material that softens at a temperature lower than the material of the mouth guard base and remains softer than the material of the mouth guard base when hardened.

U.S. Pat. No. 7,210,483 (Medtech Products, Inc.) discloses an interocclusal sports prophylaxis that includes a core having an arch-shaped occlusal plate with upwardly extending buccal and lingual walls. A labial force dispersal shield and molar framing braces extend downwardly from the plate at incisor and lingual zones of the plate. The occlusal plate is thickened at the molar and incisor zones so that breathing spaces are provided between mandibular occlusal surfaces not registered with the zones and a mandibular face of the plate. A shock absorption dentition encasement is molded over the upper surface of the core and also covers the molar and incisor zones. The prophylaxis is heated in water and then seated in the mouth. Biting pressure is applied to embed the maxillary dentition in the encasement and the lower incisor and molar occlusal surfaces in the encasement covering the zones.

U.S. Pat. No. 7,305,990 (Den-Mat Corporation) discloses a mouth guard and kit with a user-configured mouth guard. The user's teeth and gums are not directly exposed to the uncured mouth guard material. The uncured mouth guard material is pliant at room temperature and does not have to be heated to form and shape the mouth guard. The cured mouth guard can be pliant or rigid at room temperature. A kit and a method of forming the mouth guard are also disclosed.

U.S. Pat. No. 6,830,051 (Dental Concepts LLC) discloses an interocclusal appliance that includes a maxillary impression preform of a resilient thermoplastic having a low softening temperature, e.g. 36 degree C., such as an EVA copolymer having approximately thirty percent vinyl acetate. The preform is molded over and unitarily bonded to a base having a planar bottom face contacted by mandibular occlusal surfaces. The base is formed of a thermoplastic having a higher softening temperature, e.g. 70 degree C., with the bond between the preform and base characterized by high shear strength. The preform includes a bight shaped centric relation positioning channel having a thick footing and draft along lingual, buccal, and labial walls. The appliance is fitted by immersion in hot water to soften the preform, seating the maxillary arch within the channel and biting, such that the impression of the maxillary dentition embeds in the softened preform. Upon cooling, the preform is transformed into a reusable resilient encasement for the maxillary dentition. Suitable thermoplastics for implementation as the base include an EMA copolymer, blends of EMA and EVA or TPU, or blends of TPU and EVA.

The foregoing products may offer some type of improvement over standard, inexpensive athletic mouth guards. However, all have significant disadvantages as well. Such disadvantages are discussed below throughout the detailed description but generally include not accounting for a user's natural jaw position, restricting the user's airway, restricting verbal communication, and the like.

### SUMMARY

In one example according to the teachings of the present disclosure, a method of custom fitting a bite regulator includes providing a self-impression kit that has one or more bite registration tools, a bite regulator with an impression material on surfaces of the bite regulator, and instructions. The instructions direct one to: a) determine a natural bite position of a subject utilizing the bite registration tool; b) apply heat to the bite regulator to soften the impression material; c) position the bite regulator over the upper or lower teeth of the subject; d) insert the bite registration tool in the subject's mouth; and e) form an impression of a portion of the subject's teeth in the softened impression material while the bite registration tool assists the subject in maintaining the previously determined natural bite position.

In one example, the impression material can be heated in hot water, in boiling water, in a hot air stream, in a hot air enclosed space, or the like.

In one example, the step of providing can include providing a plurality of the bite registration tools.

In one example, the step of providing can include providing at least two of the bite registration tools. Each of the tools can be configured differently from one another. Each of the tools can be configured to accommodate a different natural bite position type.

In one example, the step of applying heat can include instructing that the bite regulator be placed in hot or boiling water for a predetermined amount of time.

In one example, the step of determining can include instructing that the natural fore-aft position of the subject's upper front teeth be determined relative to the subject's lower front teeth in the natural bite position.

In one example, the step of determining can include instructing that the natural vertical spacing of the subject's upper front teeth be determined relative to the subject's lower front teeth in the natural bite position.

In one example, the step of determining can include instructing that the symmetrical or natural side-to-side position of the subject's upper front teeth be determined relative to the subject's lower front teeth in the natural bite position.

In one example, the step of determining can include instructing that: a) the natural fore-aft position of the subject's upper front teeth be determined relative to the subject's lower front teeth in the natural bite position; b) the natural vertical spacing of the subject's upper front teeth be determined relative to the subject's lower front teeth in the natural bite position; and c) the natural or symmetrical side-to-side position of the subject's upper front teeth be determined relative to the subject's lower front teeth in the natural bite position.

In one example, the step of providing can include providing one or more bite forks as the bite registration tools. The bite forks can have an upper tooth positioner and a lower tooth positioner for positioning the respective upper and lower front teeth of the subject during the steps of determining and forming.

In one example, the steps of determining, applying, positioning, and inserting can include instructing that these steps be performed by the subject, by a user assisting the subject, or both.

In one example, the steps of determining, applying, positioning, and inserting can include instructing that these steps be performed by the subject.

In one example according to the teachings of the present disclosure, a kit for custom fitting a bite regulator has: a) at least one bite registration tool configured to assist a subject in determining their natural bite position; b) instructions that define a plurality of self-impression steps; and c) a bite regulator with a tooth channel on one side, interocclusal surfaces on an opposite side, a heat softening impression material exposed on the interocclusal surfaces and on surfaces within the tooth channel.

In one example, the kit can include at least two of the bite registration tools. Each bite registration tool can be configured differently from one another and can be configured to accommodate a different natural bite position type.

In one example, the bite registration tool can include tooth positioners arranged to achieve the natural fore-aft position of the subject's upper front teeth relative to their lower front teeth in the natural bite position.

In one example, the bite registration tool can have a thickness selected to achieve a predetermined vertical spacing of the subject's upper front teeth relative to their lower front teeth in the natural bite position.

In one example, the instructions can direct the subject to side-to-side position their upper front teeth relative to their lower front teeth in the natural or a symmetrical bite position.

In one example according to the teachings of the present disclosure, a bite regulator has two molar sections and a connecting band connecting the two molar sections. Each of the molar sections has a tooth channel on one side, an interocclusal surface on an opposite side, and a heat softening impression material exposed on the interocclusal surfaces and on surfaces within each tooth channel. The molar sections are sized to reach rearward a sufficient distant to only cover a first molar of a subject's teeth.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a lower bite regulator constructed in accordance with the teachings of the present disclosure.

FIG. 2 shows a front view of the lower bite regulator of FIG. 1.

FIG. 3 shows a top view of the lower bite regulator of FIG. 1.

FIG. 4 shows a bottom view of the lower bite regulator of FIG. 1.

FIG, 5 shows a side view of the lower bite regulator of FIG. 1.

FIG. 6 shows a rear view of the lower bite regulator of FIG. 1.

FIG. 7 shows a rear view of the lower bite regulator of FIG. 1, but with an optional tongue shelf on the lingual walls.

FIG. 8A shows a comparison between a prior art oral appliance and the lower bite regulator of FIG. 1 and on a lower set of teeth.

FIG. 8B shows a front view of a prior art oral appliance on a lower set of teeth.

FIG. 8C shows a front view of the lower bite regulator of FIGS. 1 and 8A on a lower set of teeth.

FIGS. 9A and 9B show cross section views of the lower bite regulator taken along lines 9A-9A and 9B-9B of FIG. 8A.

FIG. 10 shows a cross-section of the lower bite regulator between upper and lower molars of a wearer.

FIG. 11 shows a perspective view of one example of a hybrid lower bite regulator constructed in accordance with the teachings of the present disclosure.

FIG. 12 shows a front view of the lower bite regulator of FIG. 11.

FIG. 13 shows a top view of the lower bite regulator of FIG. 11.

FIG. 14 shows a bottom view of the lower bite regulator of FIG. 11.

FIG, 15 shows a side view of the lower bite regulator of FIG. 11.

FIG. 16 shows a rear view of the lower bite regulator of FIG. 11.

FIG. 17 shows a cross section of the front band of the lower bite regulator of FIG. 1 and on a set of lower teeth.

FIG. 18 shows a perspective view of one example of a hybrid lower bite regulator constructed in accordance with the teachings of the present disclosure.

FIG. 19 shows a front view of the lower bite regulator of FIG. 18.

FIG. 20 shows a top view of the lower bite regulator of FIG. 18.

FIG. 21 shows a bottom view of the lower bite regulator of FIG. 18.

FIG. 22 shows a side view of the lower bite regulator of FIG. 18.

FIG. 23 shows a rear view of the lower bite regulator of FIG. 18.

FIG. 24 shows a cross section of the front band of the upper bite regulator of

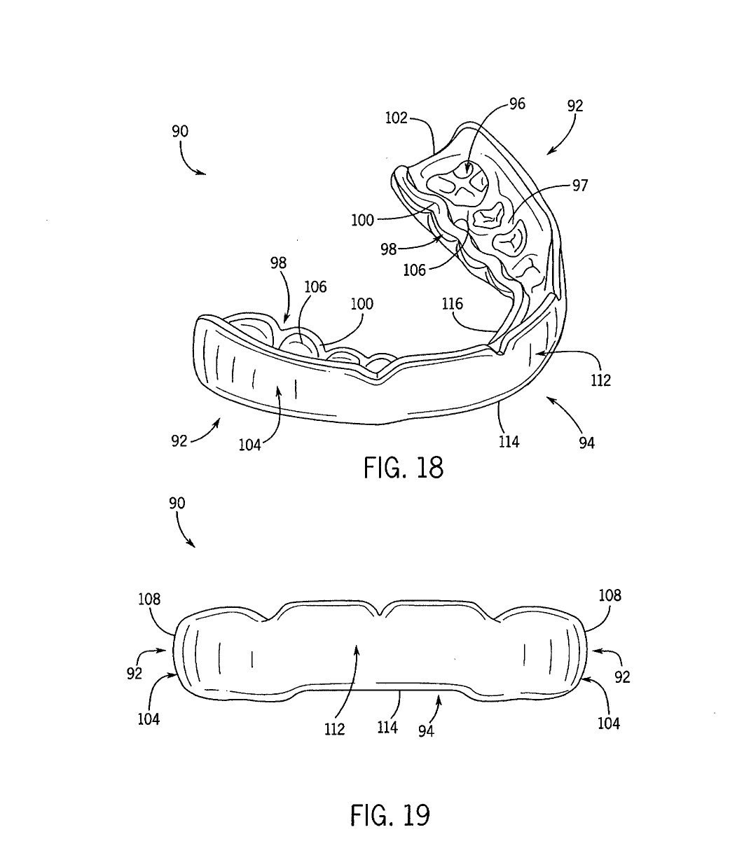

FIG. 18 and on a set of teeth.

FIG. 25 shows a perspective view of the upper bite regulator of FIG. 18 spaced from a set of upper teeth and showing differences between a prior art mouth piece and the upper bite regulator.

FIG. 26 shows a schematic representation of pull forces exerted by a person's head on the neck muscles.

FIG. 27A shows a representation of how the disclosed fitting system and resulting custom mouth piece can increases the airway opening of a user wearing the mouth piece.

FIGS. 27B shows a representation of how the disclosed fitting system and resulting custom mouth piece can stabilize the jaw of a user wearing the mouth piece.

FIG. 28 shows one example of a self-impression kit for custom fitting a bite regulator according to the teachings of the present disclosure.

FIGS. 29A and 29B show a normal Class I bite and a Class I tool of the kit in FIG. 28 in use for registering the Class I bite.

FIGS. 30A and 30B show a Class II overbite and a Class II/Class III tool from the kit in FIG. 28 in use for registering the Class II bite.

FIGS. 31A and 31B show a Class III underbite and the Class II/Class III bite for from the kit in FIG. 28 in use for registering the Class III bite.

FIG. 32A shows a bottom view of the bite regulator depicted in the kit of FIG. 28.

FIG. 32B shows a top view of the bite regulator of FIG. 32A.

FIG. 32C shows a rear view of the bite regulator of FIG. 32A.

FIG. 32D shows a partial perspective side view of one side of the bite regulator of FIG. 32A.

FIG. 32E shows a front view of the bite regulator of FIG. 32A and on a set of teeth.

FIG. 33 shows the two steps of the disclosed boil and bite fitting process for the bite regulators including heating or boiling water and placing the bite regulator in the hot or boiling water.

FIG. 34 shows the step of placing the heated bite regulator in the subject's mouth and on the teeth of the subject.

FIG. 35 shows the steps of registering the subject's bite with the selected tool of the kit of FIG. 28 and the subject biting down on the heated bite regulator.

FIG. 36 shows the bite regulator after having been fitted.

### DETAILED DESCRIPTION OF THE DISCLOSURE

The disclosed invention is for a new oral appliance called the PX3 Bite Regulator and for a method that allows individuals to self-fit such an appliance. The product design and fitting method solve or improve upon one or more problems and disadvantages with existing and prior known oral appliances, mouth guards, fitting methods, and the like.

Scientific research conducted using the disclosed oral appliances shows proven ground breaking improvements in product performance, and more important, in the performance of the athlete or user of the product. The research and test results have shown that the products can significantly reduce the occurrence of concussions in contact sports, sometimes by as much as 80% or more. Institutional research and test results have also proven a statistical increase (p>0.05) in both aerobic and anaerobic capacities. The disclosed oral appliances may be a suitable or superior replacement for virtually every mouth guard on the market. The disclosed oral appliances is proven to improve performance of individuals as they undertake any number of activities, not just contact sports, whether for youth, high school, recreational, collegiate, professional, or Olympic competition. The disclosed oral appliances have also been proven to improve the performance of military personnel, firemen, members of law enforcement, first responders and the like. The disclosed oral appliances have also been proven to improve the quality of sleep for healthy people and those suffering from sleep disorders.

The disclosed oral appliance can be categorized and described as fully customized bite-positioning mouthpieces that maintain optimized jaw alignment and allow for enhanced and unobstructed breathing. The disclosed mouthpieces also allow for unobstructed communication, and drinking, while the products are being used. The disclosed mouthpieces also allow for more efficient (higher flow with less energy demands) circulation of blood and oxygen throughout the body's internal operating systems. The disclosed PX3 Custom Bite Regulators are scientifically proven to increase oxygen volumes, heart rate variability, cognitive processing and dopamine (neurotransmitters directly linked with movement, attention, and learning), and reduces stress, anxiety and promotes a more efficient operation of the autonomic nervous system in individuals using the product in comparison to using prior or no mouthpieces.

During high impact and high stress environments, the human body's natural response is to go into a defensive state, clench the jaw and stop breathing. Lack of oxygen triggers the sympathetic nervous system to take preventative safety measures, pulling blood back from the extremities to protect vital organs, effectively shutting down parts of the brain that control fine motor skills, vision, hearing, depth perception that make simple tasks more difficult, resulting in poor performance, higher risk of mistakes and of injury. While using the disclosed PX3 Bite Regulators, testing has shown that an athlete is able to transfer higher oxygen levels by properly aligning and stabilizing the jaw position, thereby eliminating the ability to clench the teeth together and completely shut off the flow of oxygen. This feature allows the person to maintain a consistent flow of oxygen to the brain, remain calm and focused and to execute when normally they would not be able to. The effects of this increase in oxygen on training and cognitive function compounding day after day, week after week, and month after month, are measurably significant. For these types of high stress, high impact, and/or high intensity environments, it is simply not possible for one to perform at the same level with no mouthpiece, and even more difficult with a traditional mouth guard where breathing and communication is restricted through excess material or jaw misalignment.

Traditional mouth guards are not designed to increase breathing or properly align or stabilize the jaw. They are designed for protecting teeth, lips and gums. Some protective headgear products, such as football helmets, are strapped tight to a wearer's head by a taught chinstrap. This can further misalign the player's jaw, making it even harder to breath, and communicate. This further increases stress on the autonomic nervous system, reduces their ability to function, both mentally and physically and puts the athlete at a much higher risk of getting hurt or in the case of military combat, getting killed or doing long-term permanent damage. The same can be said for many individuals that regularly must perform under stressful conditions.

The disclosed oral appliances, i.e., the Custom Bite Regulators promote and enhance advanced human performance. The products are natural, clean, use only FDA approved materials, and can be used for all levels and types of competition and physical activity. The disclosed Bite Regulators are not a corrective orthotic for severe jaw disorders or pain management. The Bite Regulators are specifically designed for symmetrical alignment and stability to increase respiratory, physiological and neurological performance. The disclosed Bite Regulators are not a mouth guard or gum shield. Custom mouth guards involve one (1) single impression of the wearer's teeth and are designed for full dental coverage and minor tooth, lip and gum protection. The disclosed Bite Regulators involve nine (9) unique custom measurements: 1) full anatomy of the maxillary teeth; 2) full anatomy of the mandibular teeth; 3) full labial registration of the upper or lower gums, depending on the mouth piece model; 4) precise left side vertical positioning of maxillary and mandibular lateral incisors, canine, premolar, and molars; 5) precise right side vertical positioning of maxillary and mandibular lateral incisors, canine, premolar, and molars; 6) precise left side horizontal positioning of maxillary and mandibular lateral incisors, canine, premolar, and molars; 7) precise right side horizontal positioning of maxillary and mandibular lateral incisors, canine, premolar, and molars; 8) precise vertical positioning of maxillary and mandibular centric incisors; and 9) precise horizontal positioning of maxillary and mandibular centric incisors.

Athletic Mouth guards and many custom orthotics restrict airway, communication, misalign the bite or do not stabilize the jaw, which increases stress and energy demands on the autonomic nervous system, tiring the person faster and in doing so indirectly increasing the risk of injury during even minimal levels of physical activity. The disclosed Bite Regulators are custom fitted using dental impressions of top and bottom arches, jaw position, and proper vertical, sagittal and horizontal bite position. Existing mouth wear does not encompass all of these parameters. The disclosed Bite Regulators are designed to provide enhanced postural alignment, to stabilize the jaw, to allow for unobstructed breathing, speaking, increasing physiological performance, and indirectly reduce the overall risk of all injuries, including concussions. They are also used in sleep, rehabilitation and alternative preventative treatment options. Gains in oxygen, performance and reduction in injury risk are not a direct result of the disclosed appliances directly absorbing impact energy or chemically altering one's physiology. Instead, these improvements are mainly achieved as a result of the athlete or individual being able to consistently increase the flow and quantity of oxygen to the body, gain more efficiency of the skeletal, neurological and autonomic systems, and empower people to maintain peak power, endurance, and cognitive function longer. These and other objects, features, and advantages of the present invention will become apparent to those having ordinary skill in the art upon reading this disclosure.

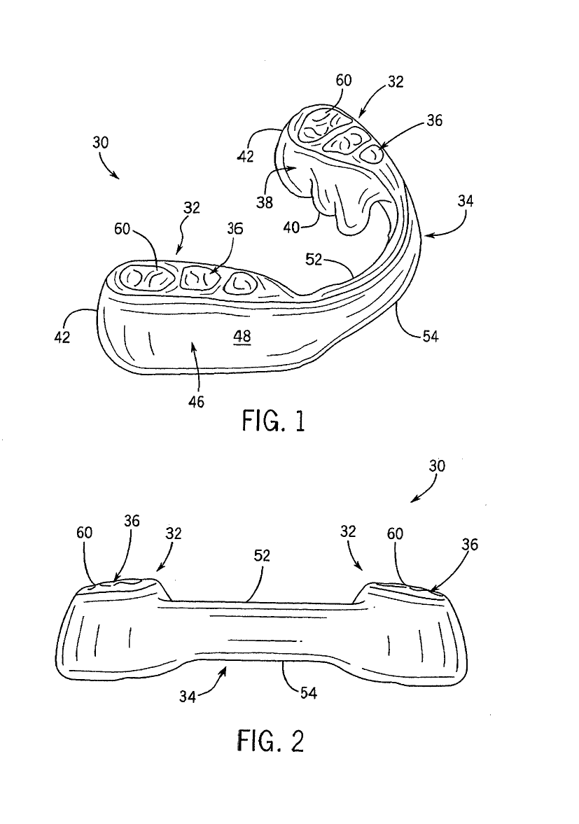

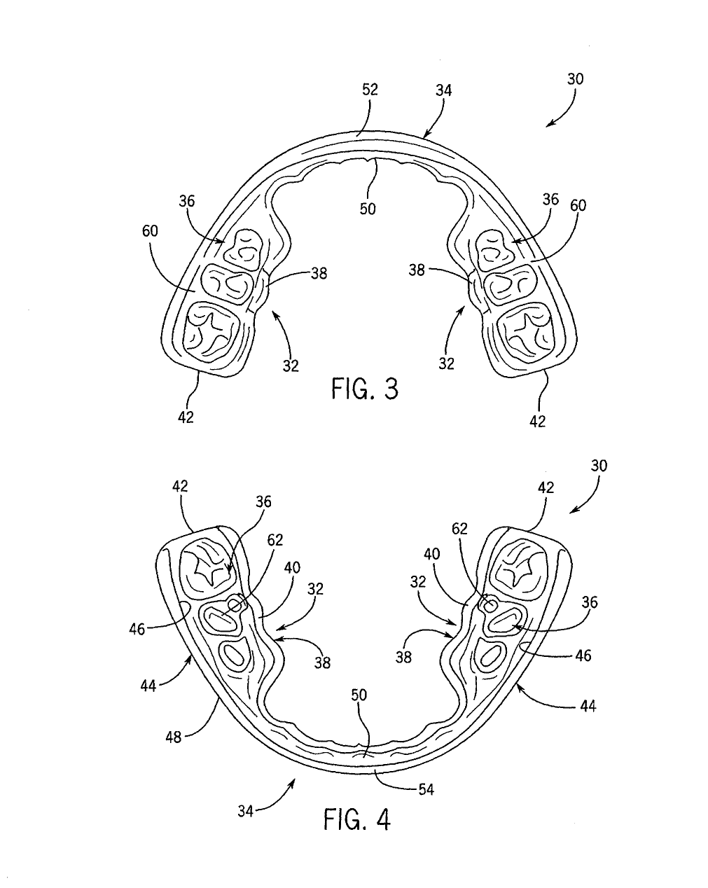

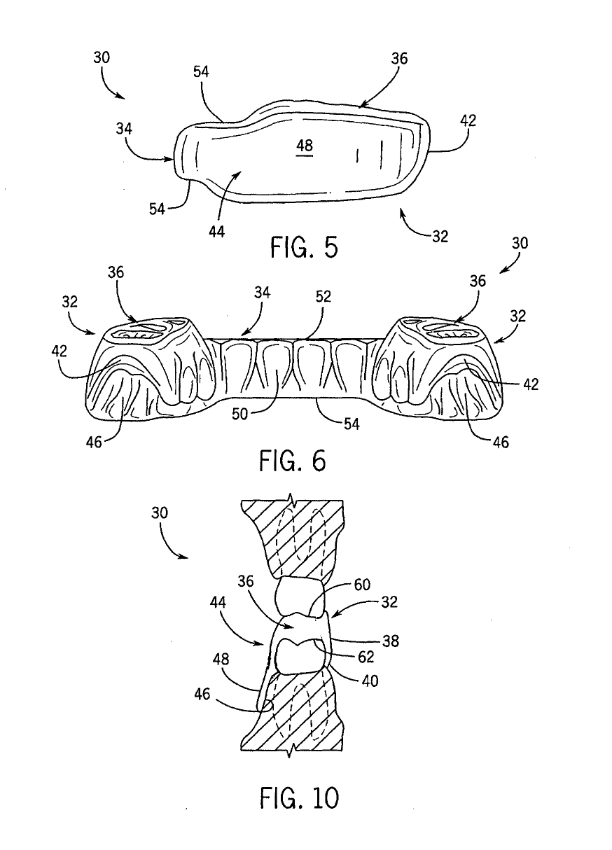

Turning now to the drawings, one example of the bite regulator or oral appliance constructed in accordance with the teachings of the present disclosure is illustrated in FIGS. 1-6. The oral appliance in this example is intended to fit over only portions of the bottom teeth of a wearer and is thus identified herein as a lower bite regulator 30. The lower bite regulator 30 has a pair of rear left and right molar sections 32 and a front band 34, or in this example a labial band interconnected to the rear molar sections at left and right ends of the labial band. The lower bite regulator 30 is unique in comparison to prior known oral appliances, mouth guards, and the like in a number of ways.

Each of the molar sections 32 has a top, relatively thick interocclusal region or portion 36 that is configured to rest between the molars of the wearer. Each molar section 32 also has a lingual wall 38 on an inner side or edge of the respective molar section. Each lingual wall 38 in this example depends downward from the respective molar section 32 and is contoured in two ways. First, the lingual wall 38 has a relatively thin wall thickness and is contoured (both inside/tooth facing side and outside/tongue facing side surfaces) to match the lateral, inner, or lingual surface contour of the adjacent molars. Second, the lingual wall 38 has a lower edge 40 that is contoured vertically so that the wall terminates at and follows the inner facing side or surface contour of the molars and does not contact any soft tissue or otherwise overlap any of the gums of the wearer. Each molar section 32 also has a short depending rear lip 42 that hangs over, in this example, a rear edge of the third (not the fourth or rearmost) molar between the third and fourth molars on each side of the wearer's mouth.

Each molar section 32 also has a buccal wall 44 on an outer side or edge of the respective molar section. In this example, the buccal walls that faces outward toward the wearer's cheek. In one example, an inner surface 46 of the buccal wall 44 can be contoured to conform to and closely follow the curvature and contour of the outer facing side of the wearer's molars. A buccal facing side or outer surface 48 of the buccal wall 44 can be relatively smooth. In another example, the outer surface or buccal facing side 48 of the buccal wall 44 could instead be contoured to generally match the contour of the inner surface 46. In such an example, the comfort for the wearer may be increased and the overall buccal wall thickness reduced to save material usage. In either example, the buccal walls 44 depend from the respective molar section 32 because the bite regulator 30 is worn on the lower teeth of a wearer. Each buccal wall 44 can have a height sufficient to cover a substantial portion of the wearer's soft tissue or gums on the buccal side of their lower teeth. In another example, in order to save material, each buccal wall can instead be contoured vertically so that the wall terminates at and follows the contour of the outer facing surfaces of the molars and does not contact any soft tissue or otherwise overlap any of the gums of the wearer.

The front band in this example is referred to as a labial band in that it is positioned on only the forward facing or labial side of the wearer's front lower teeth and interconnects the two molar sections 32. A rear side or surface 50 of the labial band 34 in this example is also contoured to custom fit or closely follow the contour of the forward facing labial surfaces of the wearer's front teeth. The height of the labial band 34 is such that a top edge 52 terminates at about the top edge of the wearer's lower front teeth but does not extend over the top edge. A lower edge 54 of the labial band terminates at about the wearer's gum line. Again, the lower edge 54 of the labial band 34 can be contoured so that no portion of the labial band extends downward to contact the soft tissue or otherwise overlap any portion of the soft tissue or gums of the wearer's mouth. In fact, the lower edge 54 of the labial band 34 can terminate above the gum line, if desired.

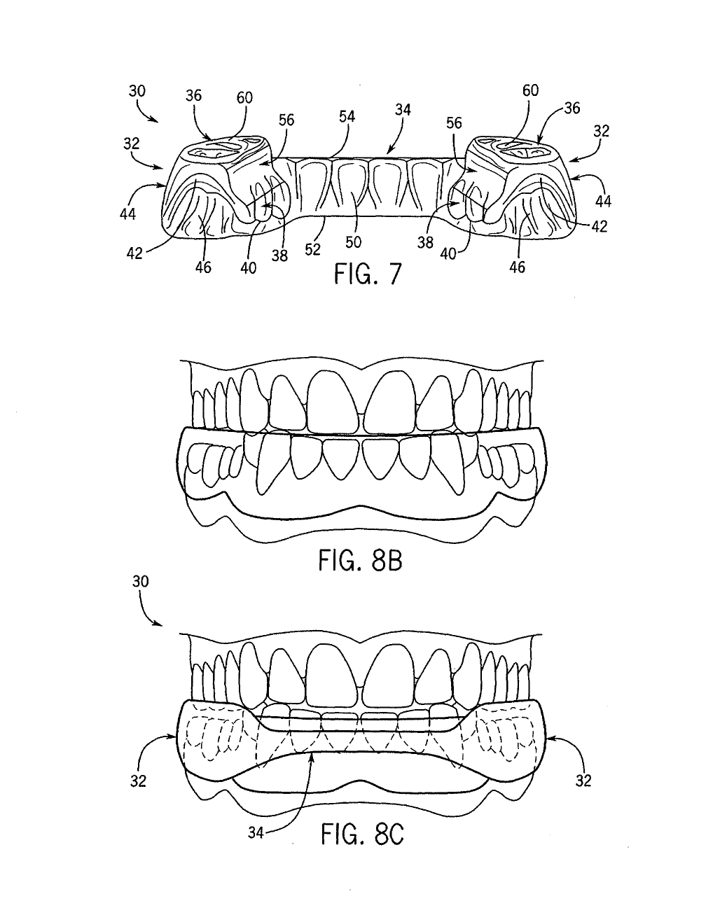

The lingual wall 38 of the molar sections 32 can include a comparatively thin wall thickness in comparison to prior known mouth guards. This can save on material usage, reduce obstruction in the wearer's airway, reduce distraction to the user wearing the device, and increase overall comfort for the wearer. Since there is less material covering the inner surface of the teeth, there is less obstruction between their tongue and the lower bite regulator during use, opening the airway and increasing comfort. The lingual wall 38 on the molar sections 32 is relatively thin because it is on the inside of the wearer's teeth and not on the outside. The lingual wall 38 of the molar sections 32 also can include an optional tongue shelf 56 in the form of a recess, depression, or scallop along the lingual wall, as shown in FIG. 7. The tongue shelf 56 can be provided to assist in properly locating the tongue for the wearer during use. The tongue shelf 56 will naturally allow the tongue to move forward, further opening the airway and providing a comfortable position resting on the lower bite regulator 30 while the device is being worn. Proper and relaxed tongue positioning will further increase oxygen intake and reduce required energy or stress on the wearer.

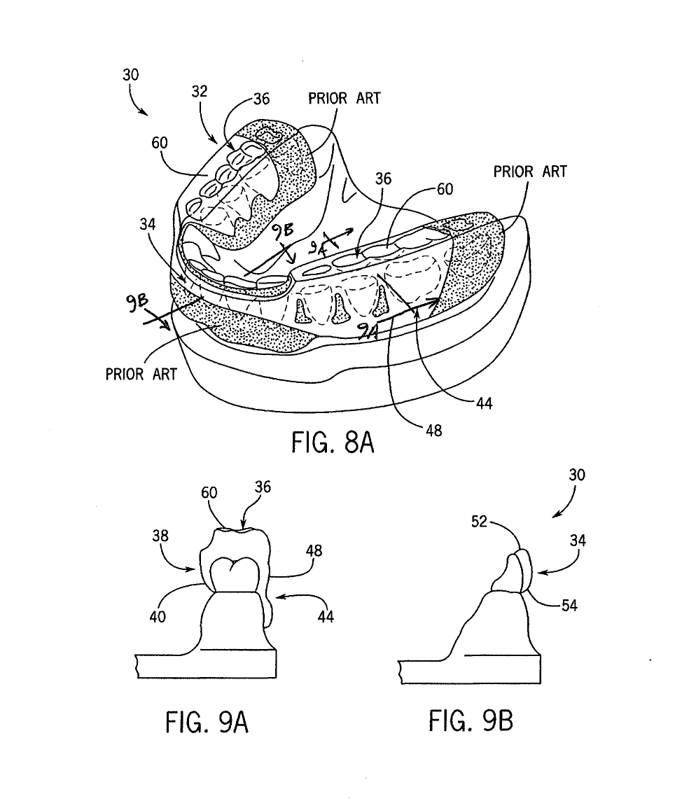

The rearward depth of the molar sections 32 on the lower bite regulator 30 is such that it does not cover all four of the molars on either side of the wearer's mouth. Instead, the molar sections 32 are truncated in comparison to prior known mouth guards, mouth pieces, oral appliances, and the like. Those prior known devices typically cover all of the wearer's molars and thus extend further rearward into the mouth and require more material to manufacture. See FIGS. 8A-8C, which show comparisons between the disclosed lower bite regulator 30 and an existing oral appliance device. FIG. 8A shows a perspective view of the lower bite regulator 30 on a set of lower teeth with the larger dimensions of existing devices depicted in the darker regions in the drawing. FIG. 8B shows a front view of a prior known oral appliance or lower mouth guard on a set of lower teeth of a wearer. FIG. 8C shows a front view of the lower bite regulator 30 on a set of lower teeth of a wearer. With the material on prior know devices extending further rearward into the wearer's mouth and further downward onto the soft tissue of the wearer's mouth, comfort is decreased, tongue interference is increased, and airway obstruction is increased. In contrast, the lower bite regulator 30 as disclosed herein uses significantly less material, eliminates this uncomfortable rear obstruction in the wearer's mouth, is much less intrusive so as to be less of a distraction to the wearer, and opens the airway for the user while wearing the device.

The top surfaces 60 of the interocclusal portions 36 of the molar sections 32 are custom molded to fit and engage the bottom facing side of the upper molars of a specific wearer or subject. The underside surfaces 62 of the interocclusal portions 36 of the molar sections 32 are custom molded to fit and engage the top side of the bottom molars of the specific wearer of subject. As described below, the positioning of these corresponding, mating depressions in the interocclusal portions 36 of the molar sections 32 is precisely fitted such that the wearer's upper and lower jaws, i.e., their bite alignment is registered and positioned for their correct or voluntary bite position, i.e., their natural and symmetrical neuromusculoskeletal alignment during use. When the wearer installs the lower bite regulator 30 and bites down on the device, their upper and lower jaws and teeth will register with one another at their correct natural or voluntary bite position and thus be in the most natural and comfortable alignment. This can significantly reduce stress in the wearer's jaw, resulting in reduced stress on the underlying parasympathetic and sympathetic systems and physiology of the wearer. During use, the wearer will naturally maintain a closed or clenched jaw position.

The disclosed lower bite regulator 30 is unique in that it still provides significant interocclusal impact protection in the same manner as a mouth guard while significantly reducing the size, material usage, and negative impact of wearing such an appliance in one's mouth during strenuous and stressful activity. See FIGS. 9A and 9B, which show a cross-section of the molar section and the labial band. The disclosed lower bite regulator 30 provides unobstructed breathing while the device is worn, allowing the wearer to consistently fuel the body, brain, and blood stream even under stressful and strenuous activity and stimulus. The disclosed lower bite regulator 30 helps to maintain a natural bite position and jaw registry for the user as well. The optional tongue shelf 56 of the lower bite regulator 30 minimizes the subconscious reaction to a foreign obstruction being placed in the mouth and helps to naturally locate or place the wearer's tongue in a relaxed, natural position within the mouth during use. The contouring on the disclosed lower bite regulator 30, and particularly the contouring on the lingual walls 38 of the molar sections 32, and the complete lack of a lingual wall on the labial band 34 in this example, significantly improves the wearer's ability to breathe and to communicate while wearing the device. See FIGS. 9A and 9B. The disclosed lower bite regulator 30 only employs thicker material regions where necessary, and particularly on the interocclusal portion 36 of the molar sections 32 between the wearer's upper and lower teeth, as depicted in FIG. 10.

The disclosed lower bite regulator 30 can be fabricated from any suitable material such as polymers or hard or soft thermoplastics. The disclosed products can also be made from more than one material, such as in a dual molding process. Likewise, the disclosed lower bite regulator 30 can be made and formed with different colored portions, clear portions, logos, and the like to enhance the aesthetic appearance and overall performance of the product. Material inserts can be fabricated during the molding process and placed, for example, in the interocclusal portions to provide further impact performance or absorption characteristics, if desired. The disclosed lower bite regulator 30 and other by regulators described herein are not intended to be limited to use of any particular material.

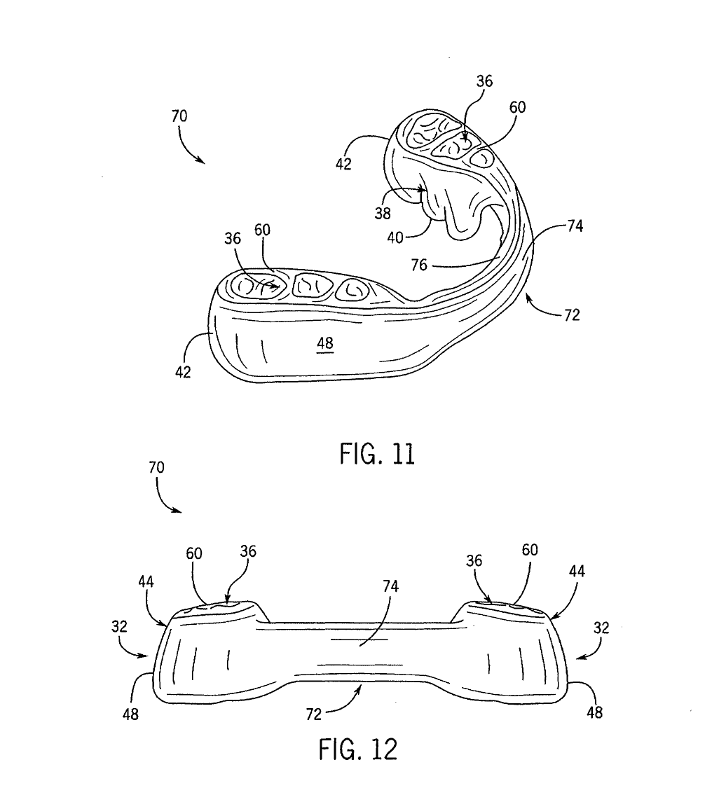

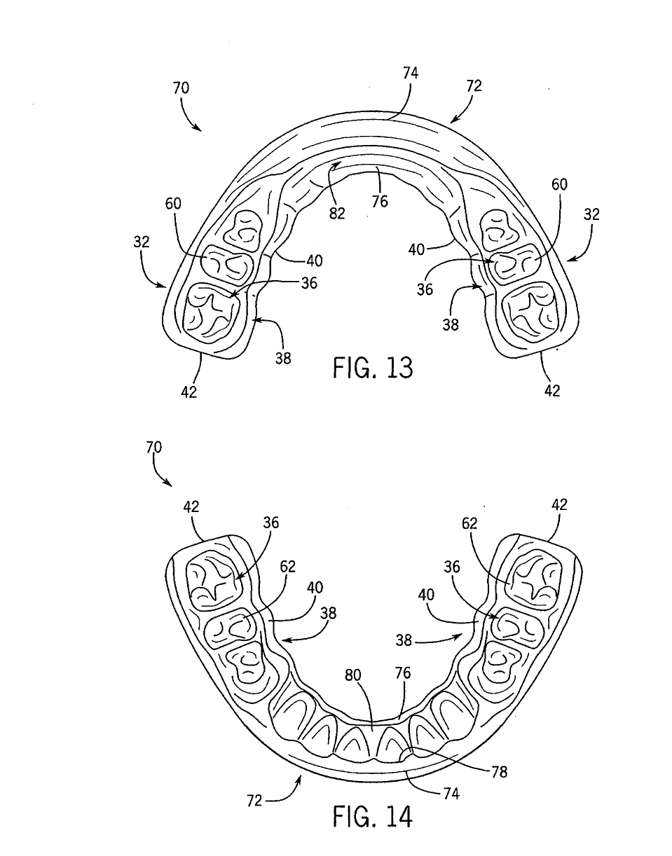

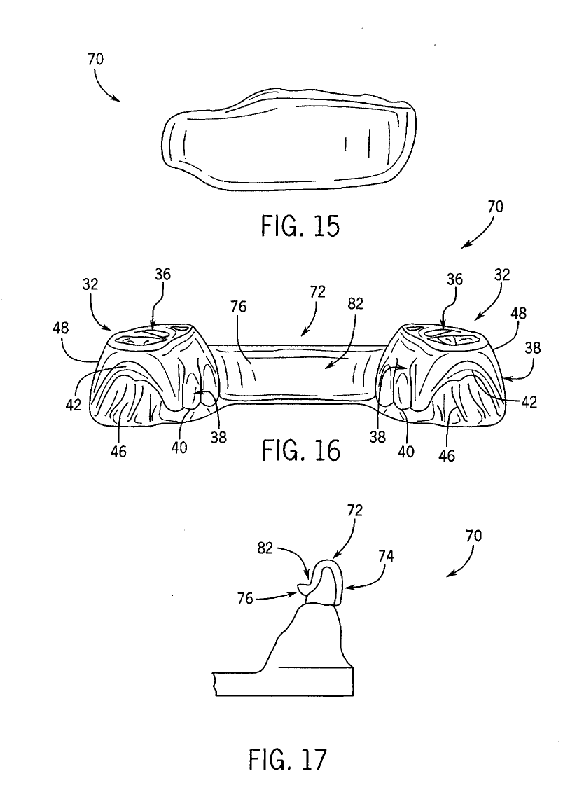

FIGS. 11-17 show another example of a lower bite regulator constructed in accordance with the teachings of the present disclosure. In this example, the lower bite regulator is constructed essentially the same as the prior described lower bite regulator except in the region of the labial band. In this example, like reference numerals refer to like parts of the lower bite regulator 30. In this example, the lower bite regulator is referred to as a hybrid lower bite regulator 70 because it provides some mouth guard functionality. Specifically, the hybrid lower bite regulator has a front band 72 with a labial wall 74 and a lingual wall 76 that replaces the labial band 34 of the above-described lower bite regulator 30. The front band 72 in this example is configured to fully cover both the labial side and lingual side of the wearer's front teeth and thus is generally U-shaped in cross-section and extends over the top edge of the front teeth. See FIG. 17.

The lingual wall 76 can be a continuation of the molar section lingual walls 38 and labial walls and the labial wall 74 can be substantially similar to the labial band 34 of the prior example. The interior surface 78 of the labial wall 74 and the interior surface 80 of the lingual wall 76 of the front band 134 in this example are each custom fitted and contoured to match the labial and lingual surface contours of the wearer's teeth. The lingual wall 76 of the front band 70 can again have a substantially thin wall thickness and can be contoured to minimize obstruction with the front of the wearer's tongue during use.

The lingual wall 76 can optionally be provided with a tongue shelf 82 that aligns with the earlier described tongue shelves 56 on the molar sections 32 to further assist in locating the wearer's tongue in a natural position while wearing the device. Alternatively, the lingual wall 76 of the front band 72 in this example can have a bottom edge that terminates above the soft tissue or gum line of the wearer and/or is contoured so as to not contact any soft tissue or otherwise overlap the gum line of the wearer. Such a limited lingual wall would likely not accommodate much of a tongue shelf. The labial or outer facing surface of the labial wall 74 in this example can be smooth or again can be contoured if desired. Providing a smooth outer surface would allow for increased wall thickness on the labial side of the labial band, which can offer better tooth protection and, thus, mouth guard functionality. This may be desirable in some circumstances because the device is a hybrid device configured to cover both sides of the front teeth and may be specifically intended to offer some mouth guard functionality.

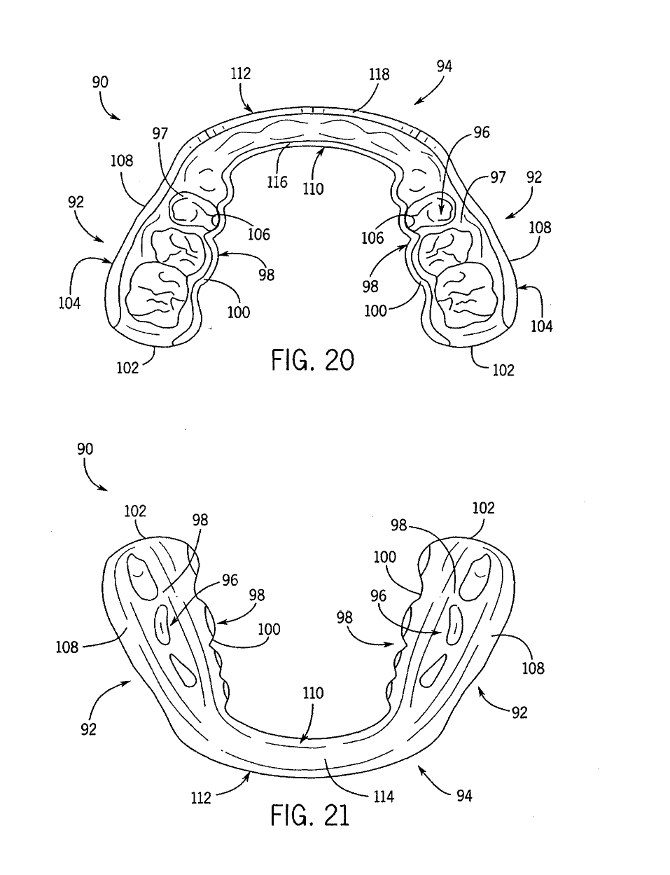

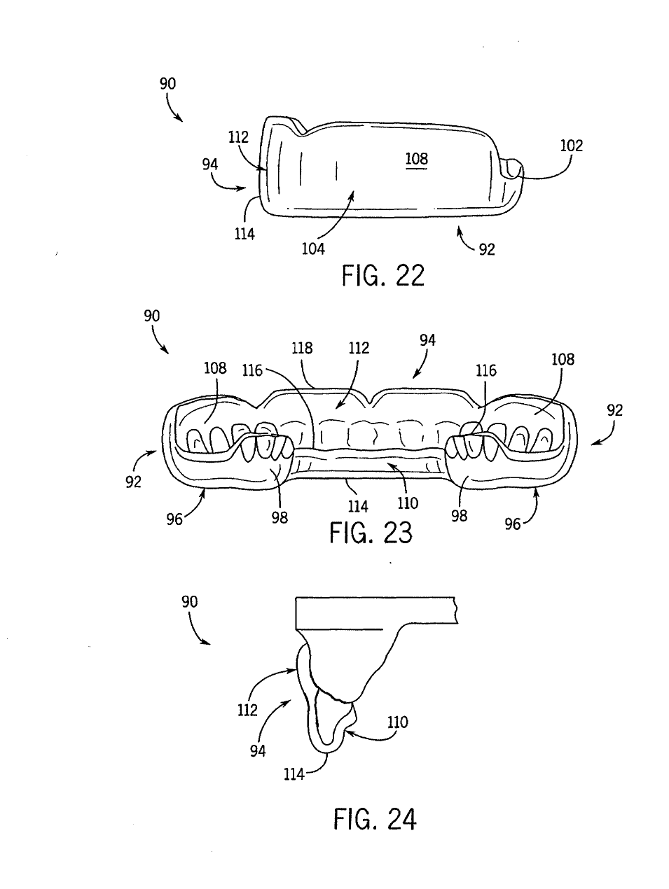

FIGS. 18-23 show another example of a bite regulator constructed in accordance with teaching of the present disclosure. In this example, the oral appliance is configured as an upper bite regulator 90 and is to be received on and conform to the upper teeth of a wearer and not the lower teeth. In general, the upper bite regulator 90 is configured similar to the earlier described lower bite regulator 30 and hybrid lower bite regulator 70, but is more similar to the lower hybrid bite regulator in that it functions in part as a protective mouth guard. The upper bite regulator 90 has left and right molar sections 92 that have essentially the same construction as the earlier described molar sections 32. However, no tongue shelf is provided, as the tongue would not be in contact with the upper device. The molar sections 92 are connected to one another by a front band 94 with left and right ends connected to the molar sections 92. Each molar section 92 has a thick interocclusal region 96 that would be positioned between the upper and lower molars of a wearer. Each molar section 92 has a top surface 97 and a bottom surface 99 that are again molded to match the contour of the wearer's upper and lower molars.

The molar sections each have a lingual wall 98 extending up from an inner edge. The lingual walls 98 can have a bottom edge 100 that is contoured to not touch, overlap, or otherwise contact the soft tissue of a wearer. The lingual walls are also contoured (both inside/tooth facing side and outside/tongue facing side surfaces) to match the contour of the adjacent molars. The molar sections 92 also can each have a rear lip 102 that protrudes up from a rearward most free end of the molar sections. Each molar section 92 also has a buccal wall 104 protruding up from an outside edge of the molar section. The inside or teeth facing surfaces 106, 108, respectively, of the lingual and buccal walls 98, 104 can be contoured to match that of a specific wearer or subject, as with the previous examples. The molar sections 92 are again designed to terminate at the third molar, not the fourth or rearmost molar and the rear lip is intended to lay against a rear surface of the third molar and reside between the third and fourth molars.

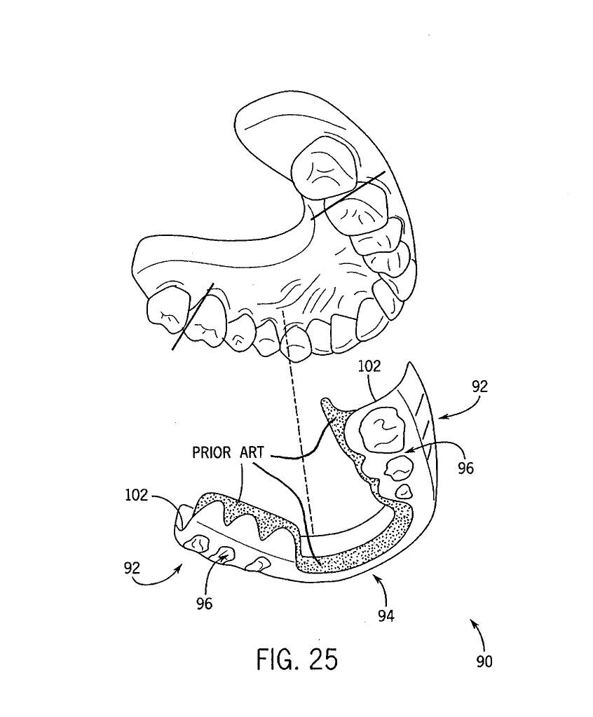

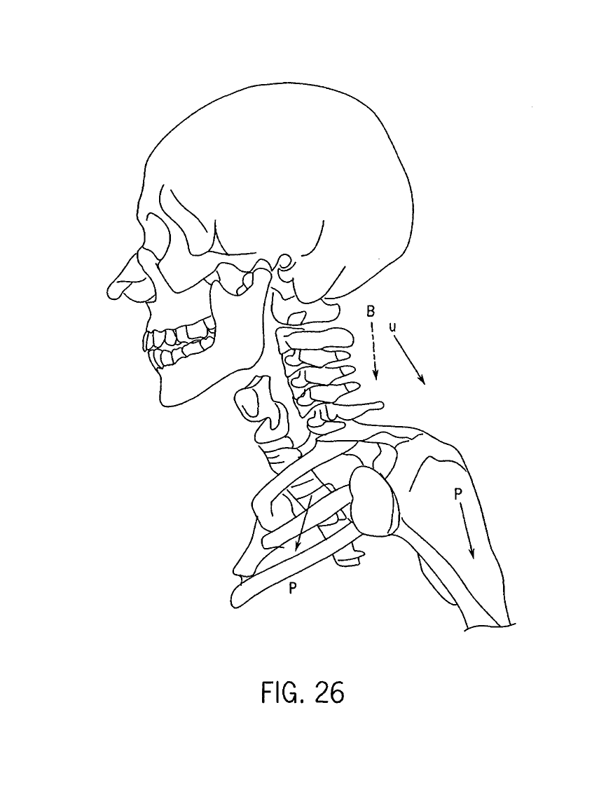

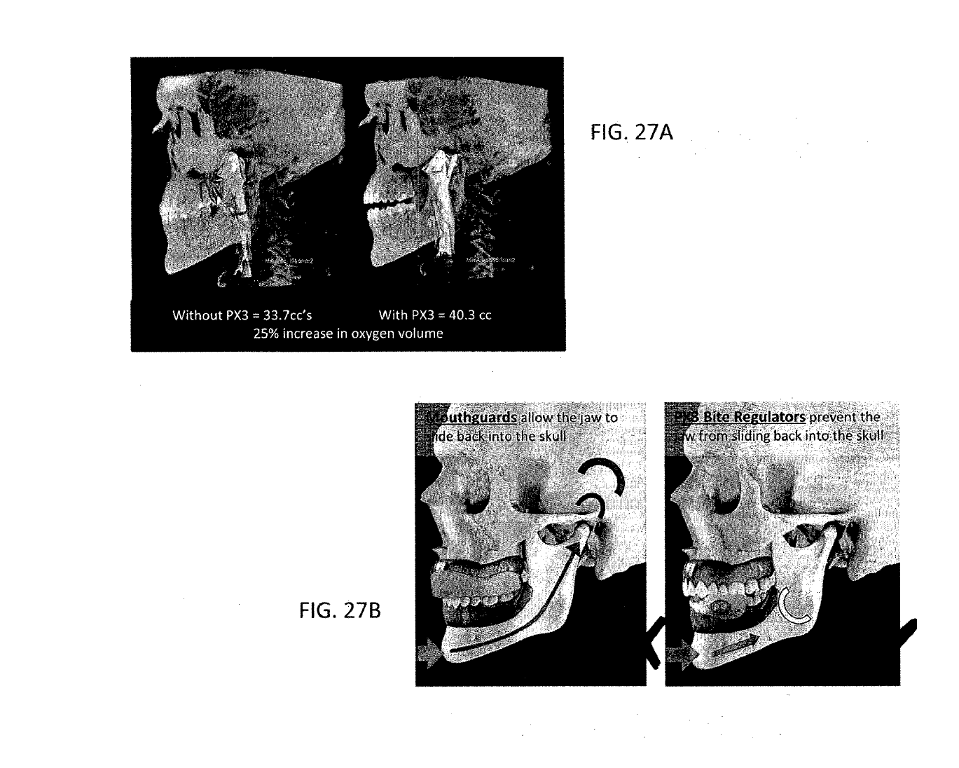

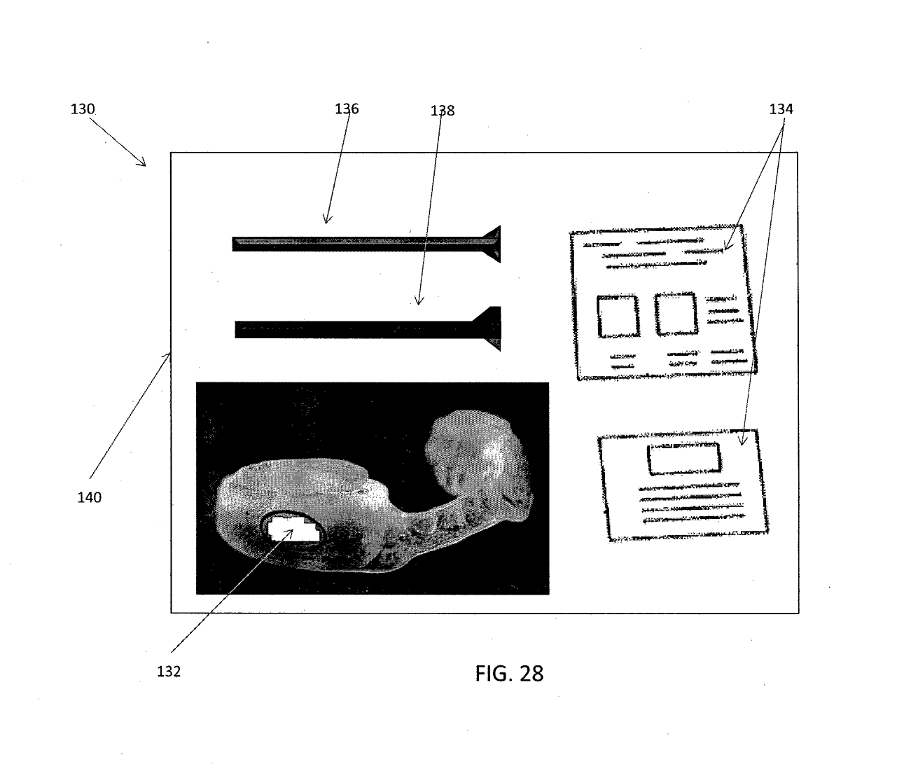

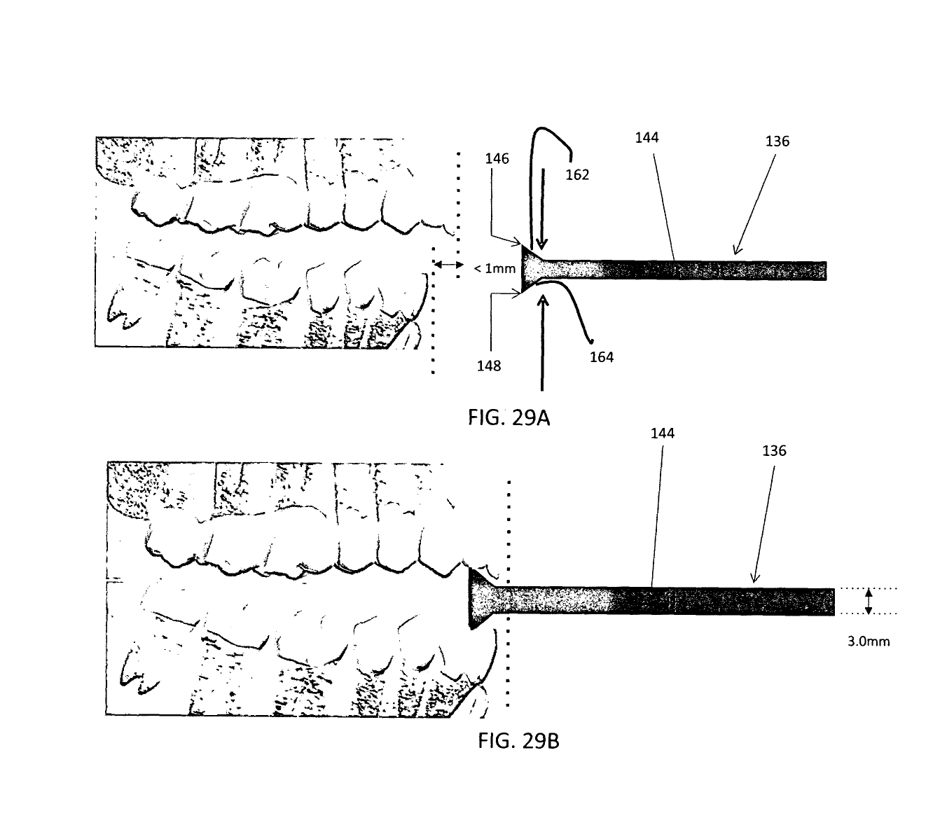

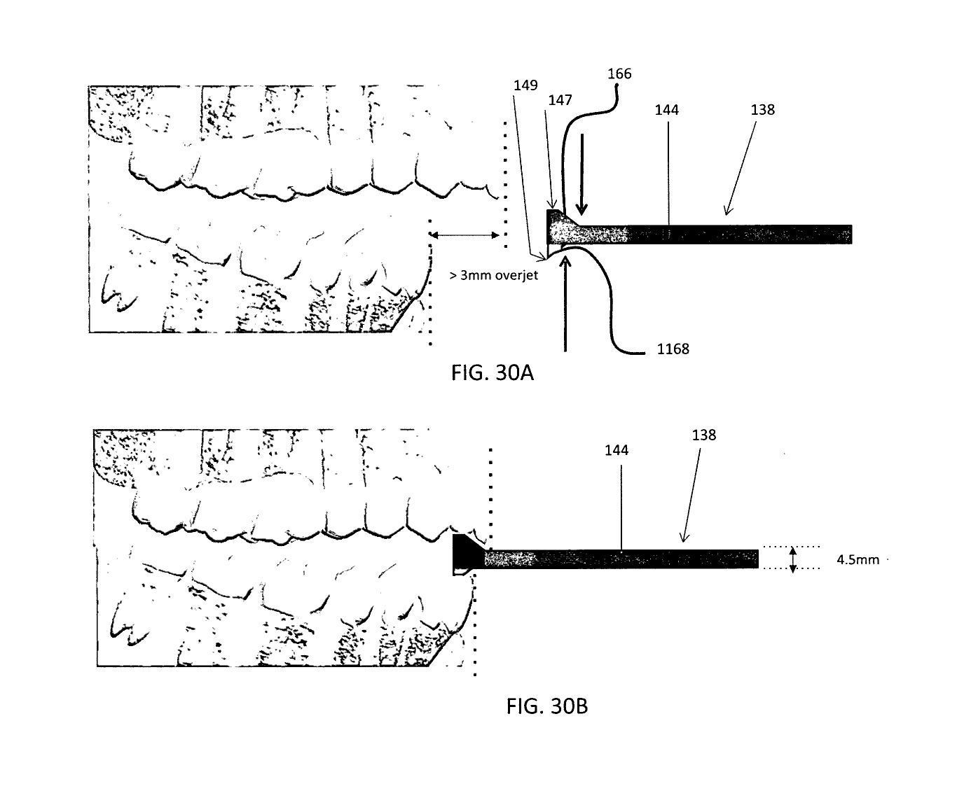

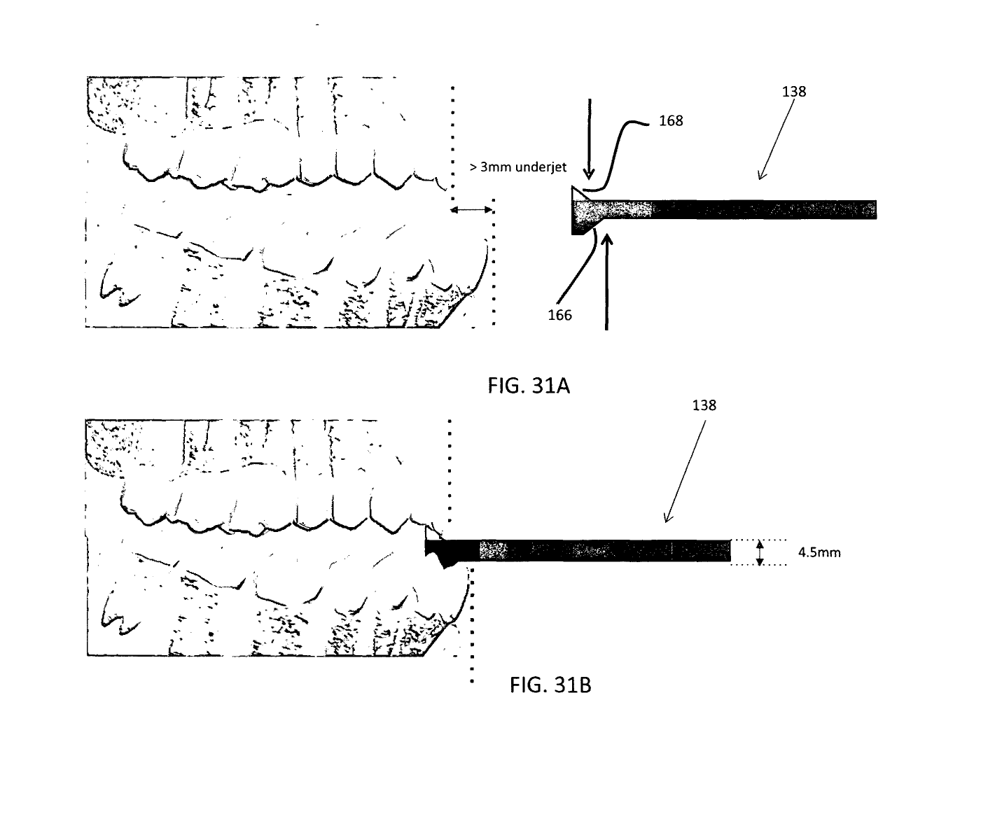

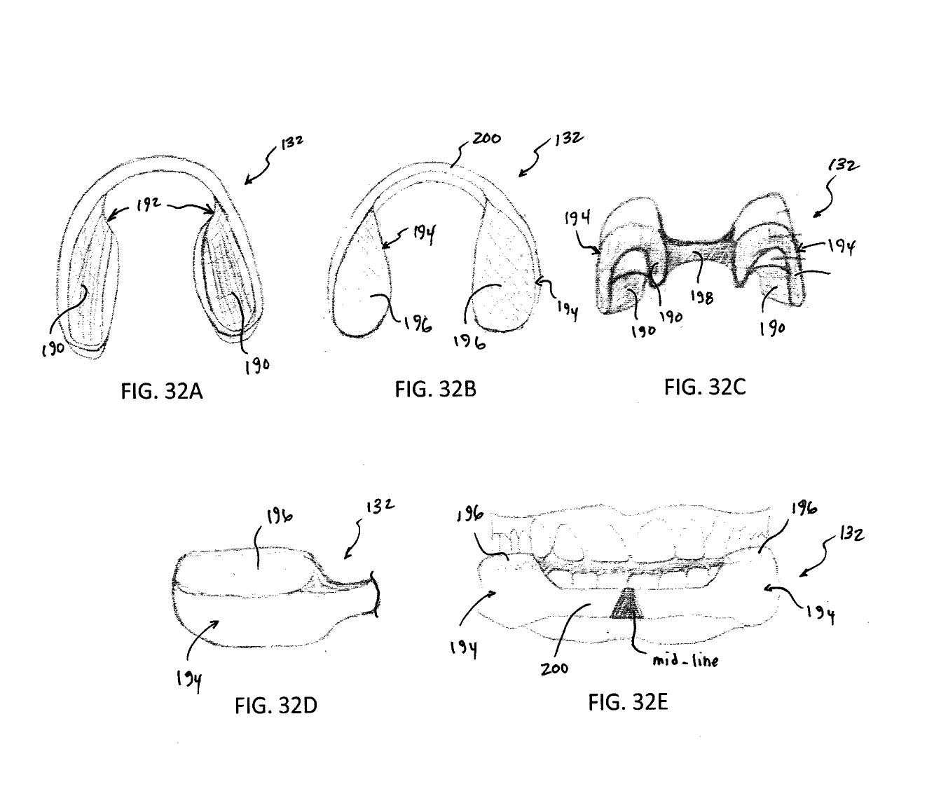

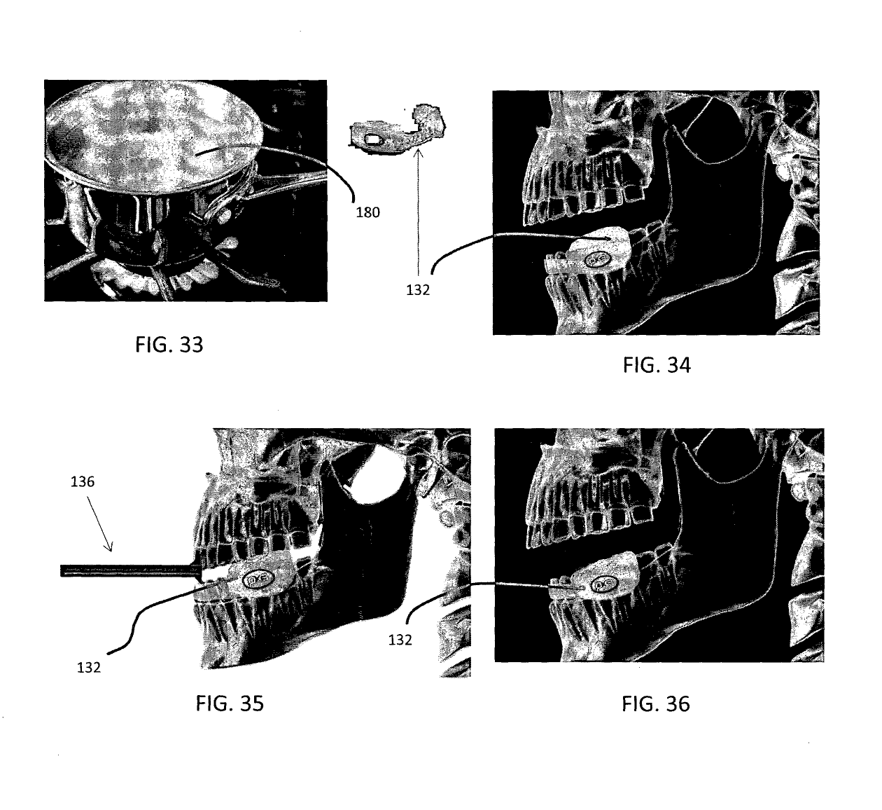

The primary difference between the upper bite regulator 90 and the lower models described above is that the upper bite regulator is configured to fit over the upper teeth of the wearer. Also, the front band 94 can be configured to provide added dental coverage and protection, imparting the addition of mouth guard functionality to the device. The front band 94 in this example can have a lingual wall 110 and a labial wall 112 joined to one another at a bottom edge 114, similar to the hybrid lower bite regulator 70, but for the upper front teeth. The lingual wall 110 can have a substantially thin wall thickness and can be contoured to match the lingual face contour of the wearer's teeth. The bottom edge 114 of the front band 94 in this example is intended to wrap around the lower edge of the wearer's upper front teeth. See FIG. 24. An upper edge 116 of the lingual wall 110 on the front band 94 can be contoured so as not to contact the soft tissue or otherwise overlap any portion of the wearer' gum line. An outer or labial surface 118 of the labial wall 112 on the front band 94 in this example can be smooth so as to allow for a more robust wall thickness covering the wearer's front teeth to enhance the mouth guard functionality of the device. The labial wall 112 can also extend upward and cover a good or substantial portion of the soft tissue or gums above over the wearer's front teeth.

FIG. 25 shows a comparison of the upper bite regulator 90 to a more conventional oral appliance of mouth guard construction. The dark areas in the drawing represent material found on the conventional device that is eliminated on the upper bite guard 90. The height of the material on the lingual wall and/or the labial wall of the front band 94 can vary. The front band 94 can alternatively be similar to the front or labial band described above on the lower bite regular of FIGS. 1-6.

On the hybrid lower bite regulator and the upper bite regulator, the interocclusal portions 36, 96 of the molar sections 32, 92 again have a much thicker wall thickness to provide impact protection. The top surfaces 60, 97 and underside or bottom surfaces 62, 99 of the respective occlusal regions 36, 96 of the molar sections 32, 92 are also custom fitted, molded, and bite registered to provide the bite registration noted above and described further below.

The disclosed bite regulator models offer high performance as a custom mouth piece. The disclosed bite regulator models are light, flexible, custom fitted polymer plastic mouth pieces that perfectly regulate a person's bite to provide enhanced breathing, clear communication, and proper skeletal alignment during sleep, physical activity, high impact and high stress activities and in such environments. The increase in oxygen naturally increases both performance and protection by allowing athletes to train harder, recover faster, react quicker, avoid fatigue longer, and maintain a steady flow of oxygen to the brain to make better decisions and take action when it matters most.

The PX3 bite regulators are proven to increase oxygen volume, dopamine levels, heart rate variability and reduce concussions. Numerous test and studies to date have proven that the superior performance of the bite regulators design. Institutional research and test results have also proven a statistical increase (p>0.05) in both aerobic and anaerobic capacities.

The fundamental principles of the disclosed bite regulators are: greater oxygen equals greater ability to perform, and greater ability to avoid injury and protect yourself. No such device or product has previously been developed, until now. The PX3 bite regulators disclosed herein are proven performance enhancing mouth pieces or oral appliances that achieve real, consistent, and measureable results with all athletes and body types during sleep, physical activity, high impact activities and in high stress environments. It is well researched and documented that oxygen levels and brain function go hand in hand, affecting motor skills, vision, hearing, reaction time, strength, flexibility, balance, the ability to learn, heal, and protect, plus thousands of other neurological responses. It is very well researched and documented that jaw position affects the flow of oxygen to the body. CPR training and certification instructs people to bring the patient's jaw forward to open up the airway. You would never push the jaw back in the throat, or move it all the way to the left or right without significantly occluding the airway. It is also very well researched and documented that a person's physiological state directly affects their ability to perform tasks, and their risk of injury to themselves or to others. This is why there are strict time schedules with airline pilots and commercial truck drivers, and why drinking and driving laws are in place—when a person's physiological state is deficient, they are more prone to hurt themselves and others.

FIG. 26 shows the skull and neck of a person with arrows depicting how jaw misalignment can negatively affect performance. Neck and back tension begin with an unbalanced bite. With good posture, one's head exerts an 8-16 pound pull on the neck muscles in the direction of the arrows P. The arrow B shows the force direction exerted when the person's bite is correctly aligned and balanced. The arrow U shows the force direction exerted when the person's bite is incorrect and out of balance. Under such unbalanced conditions, the head can exert a 30 pound pull force on the neck muscles causing strain and tension.

In sports, the jaw is always in motion. In high impact sports, the jaw is constantly being knocked around and misaligned through impact. Regardless of impact, even just with a high stress environment, the natural tendency for people is to clench down and stop breathing all together. Regardless of high impact or high stress, daily life creates repetitive stressors, which drive chronic, low-level survival responses. Over time, this process builds up, and can contribute to suboptimal performance, chronic fatigue and poor health. PX3 bite regulators, by maintaining and enhancing oxygen exchange, prevent this negative process from happening.

Knowing the role that the jaw plays and how important oxygen is to overall human function, the disclosed PX3 bite regulators have been developed to capture a person's unique and optimal breathing position and regulate the jaw in that position so that it prevents it from sliding or causing postural skeletal misalignment during high impact and high stress environments. In sports, these are typically the most crucial moments when success and failure truly matter most. In other areas of life, such as in hostile military combat, these moments are when success and survivability are defined.

The disclosed bite regulators have been developed with power, performance, and injury and disease prevention. The bite regulators have been extensively tested and developed in the most extreme high performance environments in the world. The bite regulators significantly advance this field in three key areas:

1. Reducing the risk of injuries and disease

2. Naturally increasing human performance to eliminate the need for Illegal Performance Enhancing Drugs.

3. Increasing brain and body performance and overall health.

The PX3 research council is one of the most comprehensive in sports and is made up of leading Neurologists, Physiologists, Kinesiologists, Medical Doctors, Chiropractors, Dentists, Athletic and Military Special Ops trainers, and the like. The bite regulators that have been developed have surpassed expectations in performance in these key areas.

The lower bite regulator 30 is custom fitted to lower teeth and is best in class for quality, comfort, and durability. The lower bite regulator 30 offers the highest volume of oxygen increase for these types of products. The lower bite regulator 30 also offers the clearest ability to communicate while wearing the device. The tongue is left free to move so that a wearer can speak nearly normally, even with their jaw clamped down on the device. The lower bite regulator 30 is designed for all sports, training, and physical activities where full dental coverage is not mandated.

The lower hybrid bite regulator 70 provides full dental coverage of the lower teeth for contact sports that require mouth guards while still providing all of the characteristics and benefits of the lower bite regulator 30. The lower hybrid bite regulator 70 is designed specifically for youth contact sports, such as football, ice hockey, lacrosse and field hockey, where mouth wear that provides full dental coverage of either the top or bottom teeth is mandated, but where the athletes have additional facial protection provided by the sport specific head gear. The upper hybrid bite regulator 90 provides full dental coverage of the upper teeth for contact sports that require or mandate full dental protection while still also providing all of the performance characteristics and benefits of the lower bite regulator 30.

Each of the bite regulator models is contoured on the lingual side, cut out around each individual tooth to have minimal or no contact with the lingual soft tissue. The lower and lower hybrid models can also have the added feature of additional contouring to include the tongue shelf for additional airway opening. The smooth outside or labial surface contouring can be important for long-term use and overall comfort. The thin wall thickness and contouring on the lingual walls and surfaces are also important for long term us, very comfortable fit, and increased ability to speak and breathe while wearing the device.

Tongue position can significantly affect one's airway. When the tongue comes into contact with anything in the mouth, it has been shown to naturally retract back into the throat, which occludes the airway. The tongue shelf on the lower models allows the tongue to push forward and rest comfortably, opening the air way and resting tongue muscles. The labial band or front band on the lower and lower hybrid bite regulator models comes up off the front gums and rests only on the teeth for added comfort and extended wear.

The bite regulators have been tested and proven to enhance Neuromuscular, Physiological, Neuromusculoskeletal, and Neurological performance. Every single millimeter of material and degree of bite position vertically, horizontally and sagittally on these types of devices has been found by the patentee to make a profound and instant difference in performance efficiency and comfort. The disclosed bite regulators are unique and benefit from state-of-the-art tools and technology for fabricating and fitting the devices.

The disclosed bite regulators greatly enhance performance by perfectly contouring the lingual side (upper and lower models) so as to stop at and follow the natural/unique tooth/gum line (vertical up and down) and by factoring in the natural/unique contours of the patient's teeth (horizontal in and out/side to side). On the lower guards, the tongue shelf maximizes air flow through optimized tongue alignment.

According to the Centers for Disease Control, as many as 3.8 million athletes suffer a concussion each year in the US. Even more alarming, traumatic brain injury (TBI) is the leading cause of death and disability in persons under 45 years old, occurring more frequently than breast cancer, AIDS, multiple sclerosis, and spinal cord injury combined. Other equally revealing statistics are that:
Brain injury is suffered by someone in America, usually a young person, every 15 seconds;
Each year, approximately 100,000 people die from TBI and 500,000 more are permanently disabled;
80,000 people experience the onset of long-term disability following a severe brain injury annually; and
The cost of treating, rehabilitating and caring for the victims of traumatic brain injury costs the U.S. over $50 billion each year.

Concussion testing and research are focused on the equipment and force or impact levels. It is also well documented that mouthguards have little effect in reducing concussions or the severity of concussions from an impact.

It is also well documented that most injuries happen in the second half of the game, and the second half of the season. It is also well documented that drinking and driving a vehicle at any speed, regardless of wearing a seatbelt or not, is illegal. This has driven the patentee to reevaluate the concussion issue. The patentee has considered and determined that if the integrity of the protective equipment is constant, and that impact levels over the course of competition are constant, then the physical and mental state of the athlete must be the major variable. Countless studies and programs continue to focus on the impact or acceleration forces for a possible solution. The patentee has also realized that if we only measured impact or acceleration forces in a drunk driving accident, the information on how the accident happened would not be relevant as they have occurred at every rate of speed from 5 mph to 200 mph. Without considering the physical and mental state of driver they will never fully account for why the accident happened or ever find a solution in how to reduce the risk of this happening again in the future. This has driven the patentee to reevaluate the concussion issue. Countless studies and programs continue to focus on the equipment and the force of impact, looking for a possible solution. The patentee has noticed that these tests are one dimensional, measuring external force exerted on the athlete or on the equipment and simply not relevant to the complexity or in any way measuring the internal neurological or physiological components of what is truly involved in these types of injuries.

The patentee has noted that mouth guards restrict breathing and misalign the jaw. This wears athletes down faster, making them less efficient and increasing the risks of concussions rather than having any preventative impact on reducing these risks. In fact, it has been noted that the use of mouth guards increased the frequency of concussions. The patentee's research clearly shows how mouth guards restrict breathing and negatively impact athletes on just about every physical, physiological, and neurological level. Using very basic kinesiology testing, the patentee has also clearly sees how athletes are weaker from a strength, balance, and flexibility standpoint. Mouth guards, even custom fitted mouth guards, appear to the patentee to be a bigger part of the problem than anyone has heretofore realized. The disclosed bite regulators are not mouth guards. In fact, they are the exact opposite from a neurological and physiological performance standpoint in the proven fact that the bite regulators enhance these factors rather than limit or restrict them.

The disclosed bite regulators are also not therapeutic orthotic devices. Therapeutic orthotic devices are designed to treat disorders. Such devices are not designed for unobstructed breathing or communication, are not used in high impact athletic or military environments, and are not proven to reduce concussions. Orthotics are positioned where all masticatory muscles, including all antagonistic muscle groups, such as elevators and depressors, are in the state of minimal electrical activity necessary to maintain postural rest.

The disclosed bite regulators are designed to provide proper symmetry in the mid-face and offer an enhanced voluntary bite position to increase breathing and optimize physiological and neurological performance among all body and jaw types. The 3-dimensional fitting process for the disclosed bite regulators allows the mouth pieces to be self-fitted by any individual in about 15 minutes or less.

The patentee has developed a unique X-Y-Z quadrant fitting system that pinpoints each athlete's or subject's unique vertical, horizontal, and sagittal mandible position. This unique 3-dimensional position can then be used to create a customized occlusal opening and jaw position that naturally and symmetrically aligns the jaw for optimized respiratory, skeletal, muscular, physiological, and neurological function. The disclosed fitting system allows a subject to self-fit a prefabricated but partly unformed bite regulator using a boil and bite or heat and bite technique. In the disclosed example, each bite regulator can be a nearly fully customized mouth piece that enhances postural alignment. Each mouth piece also increases the airway opening (see FIG. 27A) and stabilizes the jaw (see FIG. 27B) during sleep, physical activity, high impact and high stress activities and situations. In the disclosed example, the pre-fabricated bite regulators may not have the precise gum line formation discussed above or the precise custom fit for the body of the regulator because the bite regulator may be pre-fabricated and not fully custom fabricated from an impression of the subject's teeth and gums. However, the vast majority, if not all, of the advantages and benefits of the above-described bite regulators are achieved using the disclosed custom fitting process.

According to the teachings of the present invention, a self-impression process for custom fitting the disclosed bite regulators can take less than 15 minutes. In one example, a self-impression “boil and bite” kit can be provided directly to a user or subject to be fitted. A user can assist others to custom fit the bite regulators to a specific subject. As used herein, the term “subject” or “person” may refer to the athlete or individual intending to be custom fitted for a bite regulator. The term “user” may refer to a person assisting a subject with the self-impression, custom fitting process. The user can be a dentist, dental technician, bite regulator fabrication technician, or any third party assistant. The user may also be the subject where the subject is undertaking a pure self-impression process.

A self-impression kit assembled in accordance with the teachings of the present invention is shown in FIG. 28. In one example, the kit 130 can include one or more pre-fabricated but unfinished or unformed bite regulators 132. The bite regulators 132 are generically referenced here but can be any one of the above-described bite regulator forms described above. The kit 130 can also include instructions 134 for directing a user, or more likely, a subject to custom fit the bite regulators 132 to the subject's teeth and gums. In accordance with the teachings of the present invention, the kit 130 can also be provided with one or more bite registration tools or bite forks 136, 138 that can be used to guide and align a symmetrical bite position of the subject. The kit 130 can be provided directly to the subject or can be provided to a user by mail, courier, or at a retail store, the like and can be packaged in a single container 140. The disclosed self-impression kit and custom fitting process is easily performed by the subject in their own home. Thus, the process disclosed hereinafter is described as if the subject is performing all of the process steps.

In one example, a kit 130 can be delivered direct to a subject. The subject can follow the instructions 134 and custom fit a bite regulator 132 as described below. In another example, such a self-impression series kit 130, or the elements and components of such kits can be provided to, provided by, or housed by a professional. The professional can then provide the components of the kit, as needed, to custom fit the bite regulators 132 for each specific subject. The person or subject intending to get fitted for a bite regulator as disclosed and described herein can visit the professional facility, either a dentist or a dedicated fitting facility, where a professional will conduct the fitting, determine the subject's bite registry, and the like, as described below. However, it should be understood that a user can assist the subject in any one or more of the steps though not specifically described herein.

The bite regulators 132 for the disclosed boil and bite self-fitting process are configured for taking an impression of the subject's teeth and gums after simply heating or boiling the bite regulator in hot or boiling water. The bite regulators 132 are otherwise substantially similar in form and construction to the above disclosed lower bite regulator, hybrid lower bite regulator, and hybrid upper bite regulator. The bite regulators 132 of each type can be manufactured in a range of sizes such as extra small, small, medium, large, extra-large, and double extra-large. As noted below, the kit 130 can come with a range of sizes for the desired type of bite regulator from which the subject can select the correct size. Alternatively, the subject can order a specific size bite regulator 132 of a particular type after measuring to determine the correct size.

The size, shape, form, and quantity of the elements of the kit 130 as depicted in FIG. 28 can vary. These variables can depend on any number of factors. In one example, individual or multiple kit orders can be packaged and shipped or delivered in a single container 140. As will become evident upon reading this disclosure, the type and number of bite regulators 132 and the type and number of tools 136, 138 in a given kit can vary. The disclosed self-impression system kit 130 is not intended to be limited to the elements or components of the kit shown and described with respect to FIG. 28. However, the self-impression system kit 130 should have all of the items necessary for proper custom fitting of the bite regulators 132.

In the disclosed example, the self-impression kit 130 is provided with two different tools 136, 138. The tool 136 is a Class I bite fork with a handle 144, a top tooth positioner 146, and a bottom tooth positioner 146. On the Class I tool 136, the top and bottom tooth positioners 146, 48 are generally vertically aligned with one another. The Class I tool 136 is configured to accommodate people having a relatively normal or vertically aligned bite, as described below. The tool 138 is a Class II/Class III bite fork and similarly includes a handle 144, a top tooth positioner 147, and a bottom tooth positioner 149. The tool 138 is configured to accommodate more severe overbite and underbite malocclusal classes, i.e., Class II/Class III malocclusal conditions, as described below. The top tooth positioner 147 and bottom tooth positioner 149 are vertically misaligned or offset relative to one another in a fore and aft direction.

A series of the tools 136, 138 can also be provided whereby each fork in the range has a different vertical thickness so that the subject can find their optimal jaw/bite opening. Such a range of tools may accommodate, in one example, between a 0.5 mm vertical opening to a 8.0 mm vertical opening. Other examples are certainly possible. A series of the Class II/III tools 138 can also be provided whereby each fork has a different misalignment between the top and bottom tooth positioners 147, 149 to more precisely accommodate a range of different overbite and underbite conditions. As will become evident to those having ordinary skill in the art, the features of the tools 136, 138 can be modified to accommodate a wide range of individuals. The goal is to provide a bite registration tool for the subject to determine their natural bite and jaw position, which in turn can be used in order to create a bite regulator that accommodates the subject's natural jaw position both fore-aft and vertically. In another example, though not shown herein, a single tool can be provided with a range of thickness and multiple different tooth positioners and landing zones to accommodate different bite types.

Using the self-impression series kit 130, an athlete or subject can readily perform the various steps required for custom fitting a bite regulator 132 as described above. The instructions 134 can be designed to walk the subject step-by-step through the entire process on their own. In one example, the instructions 134 can be provided with the kit 130 in paper form with text and pictures. In another example, the instructions can be provided on another form or media in the kit 130, such as on a flash drive device, an audio disc, a video disc, or the like. The instructions 134 can be entirely in still image form, with or without text, or can be in entirely audio form, or in video form, if desired. In another example, the instructions 134 can be provided as a downloadable app for an electronic device such as a computer, smart phone, tablet, or the like. In another example, the instructions 134 can be provided via a web link and accessible on a third party server using the internet. In each case, the instructions 134 can be provided so as to guide a user or subject through the custom fitting process. The instructions 134 can also be provided in multiple different forms or in various combinations of the above examples, if desired.

With reference to FIGS. 29A-312B, the self-impression system kit 130, and thus the instructions 134, is designed to first assist the subject in determining their particular type of bite. Over 98% of the population suffers from some form of bite misalignment or malocclusion. There are three basic classifications, which are illustrated using the tools 136, 138 described above. These are based on the position of a subject's front teeth (anteriors—ancisors and cuspids) and top first molar in relation to the rest of the teeth, while in a normal bite position. The user or subject may be instructed to test and select the correct tool 136, 138 from the kit 130 to test different jaw positions via trial and error.

A Class I bite is a normal bite where the overjet or overbite of the front upper and lower incisors is within about 1 mm or less in the fore-aft direction. See FIG. 29A. For this bite, the Class I fork 136 is used, as shown in FIGS. 29A and 29B. A Class II bite is where the overbite or overjet of the front upper incisors is about 3 mm or greater than the lower teeth in the fore-aft direction. See FIG. 30A. For this bite, the Class II side of the tool 138 is used, as shown in FIGS. 30A and 30B. A Class III bite is where the underbite of the front upper incisors relative to the lower teeth is about 3 mm or greater in the fore-aft direction. See FIG. 31A. The Class III side of the tool 138 is used for this bite, as shown in FIG. 31C.

The subject can determine their bite type roughly by looking in a mirror. For this step, the subject can then take the perceived correct tool and test whether their initial assumption is correct. For a perceived normal bite, the user or subject can select the Class I tool 136 from the kit 130, as shown in FIG. 29A. Tooth contacting surfaces 162, 164 of the respective positioners 146, 148 can be ramped to better contact the subject's teeth and guide the teeth toward and into contact with the handle 144, as depicted in FIG. 29B. The tooth positioners 146, 148 allow for fore-aft play to accommodate slight variation among subjects and for bites that are within the range of a normal Class I bite, but not exactly aligned.

For a Class II bite, the subject can select the other tool 138 of this example, i.e., the Class II/III tool from the kit 130 and orient the tool in the Class II orientation as shown in FIG. 30A. Again, tooth contacting surfaces 166, 168 of the respective positioners 147, 149 can be ramped. In this orientation, the top and bottom tooth positioners 147, 149 are positioned for an overbite, putting the upper teeth forward of the lower teeth as shown in FIG. 30B. For a Class III bite, the subject can select the Class II/III tool 138 and orient the tool in the Class III orientation as shown in FIG. 31A. In this orientation, the top and bottom tooth positioners 147, 149 are positioned for an underbite, putting the upper teeth rearward of the lower teeth as shown in FIG. 31B. The Class II/III notches in tone example can be vertically misaligned by about 2.5 mm-3.0 mm.

However, the amount of offset for the notches can be greater or lesser, if desired, or a range of forks with different offsets can also be provided, as noted above. In one example, The Class II/III positioners 147, 149 can range from 2.0 mm to 6.0 mm in offset. The amount of offset for the positioners can be greater, if desired. Alternatively, the tools can be provided in a range of the forks to provide more increments so as to accommodate a wider range of bite types and degrees in order to more precisely fit each subject, if desired. The step to determine the bite type of the user can take less than 3 minutes.

The tooth positioners 147, 149 again allow for fore-aft play to accommodate slight variation among subjects and for bites that are within the range of a Class II/III bite, but not exactly the same as the offset amount of the tooth positioners.

The step to determine the bite type of the subject can take less than 3 minutes. Trial and error might be necessary to find the most comfortable, i.e., correct jaw position. The user must first determine their most comfortable jaw position, and spacing, if spacing is a considered part and function of the tools or bite forks provided. The subject can practice by placing their teeth on various ones of the tools. For each trial, the person can be instructed to perform simple physiological tests, to check their breathing, and the like in order to determine the best position for them.

The instructions 134 may then instruct the subject to make sure their teeth are clean, such as by brushing and flossing their teeth. The instructions 134 may then instruct the subject to prepare a pan 180 of water and then heat the water to a certain temperature or boil the water. This can be done before or while the subject cleans their teeth. Depending on the amount of water and the heat source, this step may take 3-5 minutes.

The instructions 134 may then direct the subject or user to take up the correct custom impression bite registration tool or bite fork, such as the bite fork 136, 138, and determine the subject's specific, correct bite type. This step can be done at any time prior to requiring the user to form the impressions in the bite regulator and can be done as described above.

The instructions 134 may then direct the subject to select and/or verify the correct size of the bite regulator 132 provided with the kit 30 or to test and select the appropriate sized bite regulator. One example of the bite regulators 132 is shown in FIG. 28 and in FIGS. 32A-32F. The bite regulator 132 can be in the form of the above-described lower bite regulator, but can also be in the form of either hybrid bite regulator described above as well. The bite regulator 132 can generally have the form of the earlier described bite regulators with all of the size and performance features. The bite regulator 132 in this specific example for the boil and bite self-impression process is described herein with respect to the lower bite regulator form. The process and product features are equally applicable to the other forms as well.

In this example, the bite regulator 132 is provided with an impression material layer 190 exposed within a channel 192 on the underside or bottom bite surface of the molar sections 194. See FIG. 32A. In one example, this material 190 can be about 2 mm thick before fitting the bite regulator 132 and can be on much or all of the surfaces of the channel 192 in order to contact the subject's teeth on the top and both sides and gums on both sides. The bite regulator 132 can also be provided with an impression material layer 196 exposed on the top bite surface of the molar sections 194. See FIG. 32B and 32D. In one example, this material 196 can be about 3 mm thick before fitting the bite regulator 132. The impression material of the layers 190, 196 can be any suitable material that can be heated to a state of ready formability and that can then cool and set to hold the formed shape. There are a number of FDA approved thermoplastic materials with such characteristics. The thickness of the impression material layers 190, 196 can also be varied from the example shown and described herein.

As shown in FIG. 32C, portions of the vertical tooth facing surfaces, particularly on the underside or bottom side of the molar sections 194 within the channel 192 can also include the impression material 190. Further, a layer of impression material 198 can also be provided on the vertical tooth facing side (lingual side) of the connecting band 198 of the bite regulator 132. See FIG. 32C. With the impression material layers 190, 196, and 198 in this example, once the bite regulator 132 is properly fitted, the bite regulator will perform more closely similar to the earlier described custom fabricated bite regulators. As shown in FIG. 32E, the front connecting band can include a mid-liner or central marker identifying the center of the bite regulator. This can aid the subject in aligning the bite regulator as discussed below.

By first undertaking the foregoing steps, the bite type of the subject is determined, the proper bite regulator type and size is selected or determined, and the proper tool 136 or 138 is also determined for the subject's bite type. The subject is then prepared to move to the next step of the self-fitting process. The instructions 134 may then direct the subject to place the selected bite regulator 132 in the pan 180 of heated or boiling water. See FIG. 33. Depending on the material construction of the bite regulator 132 and the temperature of the water, this step may take 25-35, but may certainly vary.

The instructions 134 can then direct the subject to remove the bite regulator 132 from the hot or boiling water and then place the bite regulator 132 in the proper position within the mouth. See FIG. 34. In this example, the lower bite regulator form should be placed on the user's bottom teeth, lining up the mid-line marker (see FIG. 32E) with the middle of their front teeth. This step can take about 20 seconds. In one example, the impression material can be heated in hot water, in boiling water, in a hot air stream, in a hot air enclosed space, or the like. The instructions 134 can provide suitable options or be tailored to a particular option suitable for the particular impression material on the bite regulator 132.

The instructions 134 can then direct the subject to take up the predetermined correct tool (one of the bite forks 136 or 138 in this example) and place it between their teeth in the correct orientation (if needed for Class II/III). See FIG. 35. The subject user can then be instructed to align their jaw using a mirror for sagittal alignment and by pulling on the tool to correctly position the jaw and bite registry. The subject can then be instructed to bite down slowly, concentrating on keeping or placing their jaw in a symmetrical sagittal and proper horizontal directional bite position. The vertical position will then naturally and automatically be registered as a result of the symmetrical positioning of the incisors and the thickness of the tool. These steps can take about 10 seconds. Once the subject's teeth bottom out against the tool, the user should hold the position for a suitable time to allow the impression material layers 190, 196, and 198 to cool, cure, and/or set. This step can take about one minute. However, the time for this step can vary and be longer or shorter, depending on the type of material used for the impression layers. The subject can be instructed to ensure that the tool is held fast in a horizontal position during this step of the process.

During this step of holding the impression, the instructions 134 may instruct the subject to create suction in their mouth to remove excess saliva and air. The subject can also be instructed to press lightly with their tongue against the inside surfaces of the bite regulator 132 and to press lightly with their fingers against their cheeks to apply pressure on their teeth and gums. These steps can help to maintain a tight, close bite on the bite regulator and to ensure that the impression material fully conforms to the subject's teeth and gums. These steps may be particularly helpful to make a true and close impression of the subject's teeth and gums where the impression material layers are present.

The instructions 134 may then guide to subject to check the fit of the bite regulator. The subject may be instructed to use a mirror to make sure that the X-Y-Z (sagittal, vertical, and horizontal) axes line up symmetrically and were properly retained during fitting. See FIG. 36. The user can also be instructed to determine and confirm that their teeth are registered on both the top and the bottom surfaces of the bite regulator. The user can also be instructed to determine that the top and bottom impression material layers 190, 196, 198 on all surfaces are formed and that their teeth registered on the surfaces properly.

The user can then be instructed to remove the bite regulator 132 and inspect the product after the impression steps are completed. If the impressions are not registered or not properly made on all the surfaces, the process from heating or boiling to setting can be repeated. The impression in the bite regulator should include a complete and detailed impression of at least the subject's upper and lower teeth and gums where in contact with the impression material layers. The subject should also inspect the impression to make sure it is full, complete, and satisfactorily devoid of damaged portions.

During the above self-impression fitting process, it can be important for the subject to ensure that the top middle teeth are aligned properly with the bottom middle teeth. The instructions 134 can guide the subject to do this step using a mirror, while and after biting down on the bite regulator 132 during the impression steps. This will aid in stabilizing the jaw from horizontal, vertical or sagittal movement and misalignment. See FIGS. 27A, 27B. The thickness of the tools 136, 138 between the front incisors can be designed to set a desired or an optimal sagittal position and/or vertical opening between the upper and lower teeth for the subject. In one example, the thickness of the tool can range from 2 mm to as much as 6 mm.

In order to obtain the best possible impressions according to the foregoing methods, the subject and/or user can try and be careful in several of the steps. For one, the subject should try and ensure contact of all of the front teeth and the first molar with impression material layers. The user and/or subject should also be careful not to twist, turn or move the tool and bite regulator during the process. This is to avoid blurring the impressions. The subject should also try and apply pressure over all the inside or lingual soft tissue, both the upper and lower gums, using their tongue. The subject can also try and apply pressure to all the outside or labial soft tissue, both the upper and lower gums, with their fingers so that the impression fully takes gum line to gum line. This can be important to ensure an accurate and complete impression.

As noted, the self-impression process may be performed entirely by the subject to be fitted or at least in part by another user assisting the subject with the process. The self-impression process described herein can also include more or fewer steps than the example described. The entire kit 130 may be provided to the subject or user. Alternatively, the kit components can be provided to the subject or user in piecemeal fashion. Once the complete impression is taken, the end result is a custom fitted bite regulator. This single unit can be used immediately by the subject.

The tools can be constructed from any suitable material and can be modified from the various examples disclosed and described herein. In one example, the tooth positioners can be provided at the tip of the handles or spaced from the tip. They can be in the form of ramps, or walls, or rounded spheres, hemi-spheres, one large sphere, or the like. As noted above, the thickness of the handles can also vary. In one example, different versions of the tools can be produced with different thicknesses to accommodate and produce a different vertical spacing for each fork. The height, thickness, and width of the tooth positioner elements can also vary.

No one has heretofore developed or offered a self-impression system and fully customized bite regulator mouth piece that registers the top teeth, bottom teeth, vertical spacing on the left, right and middle occlusal with kits or steps. The self-impression or professional fitting process can also utilize the aforementioned digital process or a one-step impression process instead of the two-step process described in detail herein.

Boil n Bite (Patient—impression+bite registration tool)

PX3 bite registration tool to register the bite

Boil n Bite Fitting process: 2 steps

PX3 bite registration tool to register the bite

In one example, the bite regulator models can have the following dimensional characteristics. It should be noted that the invention is not to be limited to the following examples.

Lower Bite Regulator

Buccal extension—0.5 to 3 mm apical from CEJ

2.0 mm to 6.0 mm thick

Flat, no contouring

Lingual extension—0.5 mm to 3.0 mm apical of CEJ

0.5 mm to 3 mm thick

Embrasure contouring begins 0.5 mm to 3.0 mm apically from occlusal table

Feather edge lingual termination

Guard terminates at the mesial half of second molar

Round off distal lingual of last tooth covered by guard

Open/Flatten off buccal aspect of cuspid index

Occlusal index

0.5 mm to 3.0 mm on lingual cusps

0.5 to 3.0 mm on buccal cusps

0.5 to 3.0 mm on lingual and buccal cusps of last tooth indexed

Labial connector

Polished intaglio, so there is little to no contact to hard and soft tissue

2.0 mm to 5.0 mm width from CEJ to incisal edge

Contoured when needed at labial frenum

Cuspid coverage extends no more than half of the tooth

Lingual cuspid concavity

No indexing past cuspids

Tongue Shelf

small concavity created on lingual

concavity extends throughout whole lingual surface posterior to anterior

concavity begins at occlusal table and extends only to beginning of embrasure line

concavity size is determined on the amount of material built on occlusal table. Some guards may have longer concavities due to space from occlusal table to embrasure line.

Lingual contouring

Hybrid Upper Bite Regulator

Buccal extension—0.5 to 3.0 mm apical from CEJ

0.5 to 5.0 mm thick

Flat, no contouring

Palatal extension—1 mm apical of CEJ

0.5 to 3.0 mm thick

0.5 to 3.0 mm from incisal edge to cingulum of anterior teeth (cuspid to cuspid)

Embrasure contouring begins 0.5 to 3.0 mm apically from occlusal table

Feather edge palatal termination

Guard terminates at the mesial half of the second molar

Round off distal palatal of last tooth covered by guard

Open/Flatten off buccal aspect of cuspid index

Occlusal index

0.5 to 3.0 mm on lingual cusps

0.5 to 3.0 mm on buccal cusps

0.5 to 3.0 mm on lingual and buccal cusps of last tooth indexed

Cuspid palatal coverage extends no more than half the tooth

No indexing past cuspids

Lingual contouring

The disclosed self-fitting process can take a subject less than 15 minutes. The disclosed custom fitting process of the bite regulators is also completely unique in that it takes into account the subject's bite registry when forming the impressions in the product.

Bite regulators and features and self-impression processes, steps, systems, methods, components, and kits are disclosed herein and numerous performance and design aspects are disclosure for same. Various combinations of these features, processes, systems, methods, components, and kits can be provided on a given bite regulator or kit or performed for a given process. Any one of these disclosed features and processes, steps, systems, methods, components, and kits may be provided either separate from or in combination with any one or more of the other of same, where possible, even though that particular combination or arrangement is not specifically disclosed or described herein.

Although certain bite regulators and features and self-impression processes, steps, systems, methods, components, and kits have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A method of custom fitting a bite regulator, the method comprising:
providing a self-impression kit including one or more bite registration tools, a bite regulator with an impression material on surfaces of the bite regulator, and instructions, the instructions directing the following steps:
determining a natural bite position of a subject utilizing the bite registration tool,
applying heat to the bite regulator to soften the impression material,
positioning the bite regulator over the upper or lower teeth of the subject,
inserting the bite registration tool in the subject's mouth,
forming an impression of a portion of the subject's teeth in the softened impression material while the bite registration tool assists the subject in maintaining the previously determined natural bite position.

2. The method according to claim 1, wherein the step of providing includes providing a plurality of the bite registration tools.

3. The method according to claim 2, wherein the step of providing includes providing at least two tools of the plurality of bite registration tools are configured differently from one another, each being configured to accommodate a different natural bite position type.

4. The method according to claim 1, wherein the step of applying heat includes instructing that the bite regulator be placed in hot or boiling water for a predetermined amount of time.

5. The method according to claim 1, wherein the step of determining includes instructing that the natural fore-aft position of the subject's upper front teeth be determined relative to the subject's lower front teeth in the natural bite position.

6. The method according to claim 1, wherein the step of determining includes instructing that the natural vertical spacing of the subject's upper front teeth be determined relative to the subject's lower front teeth in the natural bite position.

7. The method according to claim 1, wherein the step of determining includes instructing that the natural side-to-side position of the subject's upper front teeth be determined relative to the subject's lower front teeth in the natural bite position.

8. The method according to claim 1, wherein the step of determining includes instructing that:
the natural fore-aft position of the subject's upper front teeth be determined relative to the subject's lower front teeth in the natural bite position;
the natural vertical spacing of the subject's upper front teeth be determined relative to the subject's lower front teeth in the natural bite position; and
the natural side-to-side position of the subject's upper front teeth be determined relative to the subject's lower front teeth in the natural bite position.

9. The method according to claim 1, wherein the step of providing includes providing one or more bite forks as the bite registration tools, the bite forks having an upper tooth positioner and a lower tooth positioner for positioning the respective upper and lower front teeth of the subject during the steps of determining and forming.

10. The method according to claim 1, wherein the steps of determining, applying, positioning, and inserting further including instructing that these steps be performed by the subject, by a user assisting the subject, or both.

11. The method according to claim 10, wherein the steps of determining, applying, positioning, and inserting further include instructing that these steps be performed by the subject.

12. A kit for custom fitting a bite regulator, the kit comprising:
at least one bite registration tool configured to assist a subject in determining their natural bite position;
instructions that define a plurality of self-impression steps; and
a bite regulator with a tooth channel on one side, interocclusal surfaces on an opposite side, a heat softening impression material exposed on the interocclusal surfaces and on surfaces within the tooth channel.

13. The kit according to claim 12, further comprising at least two of the bite registration tools, each bite registration tool configured differently from one another and being configured to accommodate a different natural bite position type.

14. The kit according to claim 12, wherein the bite registration tool includes tooth positioners arranged to achieve the natural fore-aft position of the subject's upper front teeth relative to their lower front teeth in the natural bite position.

15. The kit according to claim 12, wherein the bite registration tool has a thickness selected to achieve predetermined vertical spacing of the subject's upper front teeth relative to their lower front teeth in the natural bite position.

16. The method according to claim 12, wherein the instructions direct the subject to side-to-side position their upper front teeth relative to their lower front teeth in the natural bite position.

17. A bite regulator comprising:
two molar sections;
a connecting band connecting the two molar sections;
a tooth channel on one side of each molar section;
an interocclusal surface on an opposite side of each molar section; and
a heat softening impression material exposed on the interocclusal surfaces and on surfaces within each tooth channel,
wherein the molar sections are sized to extend rearward a sufficient distant to only cover a first molar of a subject's teeth.
